(19) United States
(12) Patent Application Publication
(10) Pub. No.: US 2026/0352292 A1
(43) Pub. Date: Nov. 5, 2026

(54) UCI REPORTING IN WIRELESS COMMUNICATION SYSTEMS

(71) Applicant: Samsung Electronics Co., Ltd., Suwon-si (KR)

(72) Inventors: Md. Saifur Rahman, Plano, TX (US); Eko Onggosanusi, Coppell, TX (US)

(21) Appl. No.: 19/572,734

(22) Filed: Mar. 19, 2026

Related U.S. Application Data
(60) Provisional application No. 63/786,763, filed on Apr. 10, 2025.

(51) Int. Cl. H04B 7/06; H04L 41/16

(52) U.S. Cl. CPC H04B 7/0626; H04L 41/16

(57) ABSTRACT

Apparatuses and methods for uplink control information (UCI) reporting in wireless communication systems. A method performed by a user equipment (UE) includes receiving information about a channel state information (CSI) report based on a basis. The basis comprises K vectors, and the basis is associated with P ports and N_{SB} SBs, where K>1. The method further includes selecting L out of K vectors, where 1≤L≤K, determining L coefficients, one for each of the selected L vectors, and transmitting the CSI report including a first indicator indicating indices of the selected L vectors, a second indicator indicating amplitudes of the L coefficients, and a third indicator indicating phases of the L coefficients.

### CROSS-REFERENCE TO RELATED AND CLAIM OF PRIORITY

The present application claims priority under 35 U.S.C. § 119(e) to U.S. Provisional Patent Application No. 63/786,763 filed on Apr. 10, 2025. The above identified provisional patent application is hereby incorporated by reference in its entirety.

### TECHNICAL FIELD

The present disclosure relates generally to wireless communication systems and, more specifically, the present disclosure is related to apparatuses and methods for uplink control information (UCI) reporting in wireless communication systems.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to UCI reporting in wireless communication systems.

In one embodiment, a user equipment (UE) is provided. The UE includes a transceiver configured to receive information about a channel state information (CSI) report based on a basis. The basis comprises K vectors, and the basis is associated with P ports and N_{SB} SBs, where K>1. The UE further includes a processor operably coupled to the transceiver. The processor is configured to select L out of K vectors, where 1≤L≤K and determine L coefficients, one for each of the selected L vectors. The transceiver is further configured to transmit the CSI report including a first indicator indicating indices of the selected L vectors, a second indicator indicating amplitudes of the L coefficients, and a third indicator indicating phases of the L coefficients.

In another embodiment, a base station (BS) is provided. The BS includes a processor and a transceiver operably coupled to the transceiver. The processor is configured to transmit information about a CSI report based on a basis, the basis comprises K vectors, and the basis is associated with P ports and N_{SB} SBs, where K>1; and receive the CSI report including a first indicator indicating indices of L vectors selected out of the K vectors, where 1≤L≤K, a second indicator indicating amplitudes of L coefficients, one for each of the L vectors, and a third indicator indicating phases of the L coefficients.

In yet another embodiment, a method performed by a UE is provided. The method includes receiving information about a CSI report based on a basis. The basis comprises K vectors, and the basis is associated with P ports and N_{SB} SBs, where K>1. The method further includes selecting L out of K vectors, where 1≤L≤K, determining L coefficients, one for each of the selected L vectors, and transmitting the CSI report including a first indicator indicating indices of the selected L vectors, a second indicator indicating amplitudes of the L coefficients, and a third indicator indicating phases of the L coefficients.

Other technical features may be readily apparent to one skilled in the art from the following FIGURES, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates example radio access network (RAN) configurations according to embodiments of the present disclosure;

FIG. 7 illustrates an example antenna port layout according to embodiments of the present disclosure;

FIG. 8 illustrates a timeline of example spatial-domain (SD) units and frequency-domain (FD) units according to embodiments of the present disclosure;

FIG. 9 illustrates an example codebook according to embodiments of the present disclosure;

FIG. 10 illustrates an example artificial intelligence (AI)-native CSI configuration according to embodiments of the present disclosure;

FIG. 11 illustrates an example convolution operation according to embodiments of the present disclosure;

FIG. 12 illustrates an example complex-values matrix/vector according to embodiments of the present disclosure;

FIG. 13 illustrates an example neural network based auto encoder according to embodiments of the present disclosure;

FIG. 14 illustrates an example neural network based linear auto encoder according to embodiments of the present disclosure;

FIG. 15 illustrates an example neural network based non-linear auto decoder according to embodiments of the present disclosure;

FIG. 16 illustrates an example two-sided model procedure according to embodiments of the present disclosure;

FIG. 17 illustrates an example linear auto encoder according to embodiments of the present disclosure;

FIG. 18 illustrates an example multi-layer linear auto encoder according to embodiments of the present disclosure;

FIG. 19 illustrates an example non-linear auto encoder according to embodiments of the present disclosure;

FIG. 20 illustrates an example multi-layer non-linear auto encoder according to embodiments of the present disclosure;

FIG. 21 illustrates an example of reconstructing the channel state information (CSI) data matrix according to embodiments of the present disclosure;

FIG. 22 illustrates another example of reconstructing the CSI data matrix according to embodiments of the present disclosure;

FIG. 23 illustrates an example of configuring a UE with a CSI report based on a codebook having a basis in a spatial domain (SD) and a frequency domain (FD) according to embodiments of the present disclosure; and

FIG. 24 illustrates a flowchart of an example method performed by a UE in a wireless communication system according to embodiments of the present disclosure.

### DETAILED DESCRIPTION

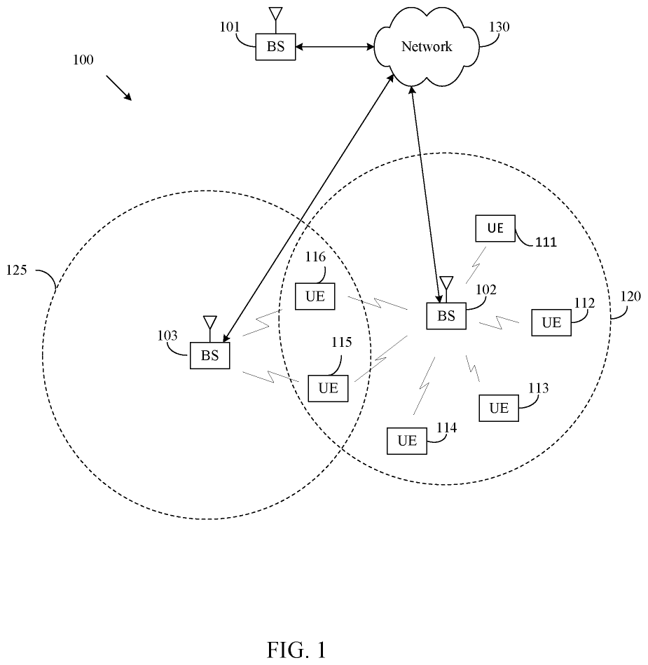

FIGS. 1-24 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

In the 5G system, Hybrid frequency shift keying (FSK) and QAM Modulation (FQAM) and sliding window superposition coding (SWSC) as an advanced coding modulation (ACM), and filter bank multi carrier(FBMC), non-orthogonal multiple access(NOMA), and sparse code multiple access (SCMA) as an advanced access technology have been developed.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1]3GPP, TS 38.211, 5G; NR; Physical channels and modulation; [REF 2]3GPP, TS 38.331, 5G; NR; Radio Resource Control (RRC); Protocol specification; [REF 3]3GPP, TS 38.321, 5G; NR; Medium Access Control (MAC); Protocol specification; [REF 4]3GPP, TS 38.214, 5G; NR; Physical layer procedures for data; [REF 5] https://mathworld.wolfram.com/ToeplitzMatrix.html; [REF 6]M. Wax and T. Kailath, “Efficient inversion of a doubly block Toeplitz matrix”, in Proc. IEEE ICASSP, pp. 170-173, Apr. 14-16, 1983; [REF 7] https://mathworld.wolfram.com/CirculantMatrix.html; [REF 8]A. Araujo, “Building Compact and Robust Deep Neural Networks with Toeplitz Matrices”, https://arxiv.org/pdf/2109.00959.pdf; [REF 9]3GPP TS 38.212 v18.0.0, “E-UTRA, NR, Multiplexing and Channel coding;” [REF 10]3GPP TS 38.213 v18.0.0, “E-UTRA, NR, Physical Layer Procedures for Control;” [REF 11]O-RAN.WG4.CONF.0-R003-v09.00, “O-RAN Working Group 4 (Fronthaul Working Group) Conformance Test Specification;” [REF 12]O-RAN.WG4.CUS.0-R003-v13.00, “O-RAN Working Group 4 (Open Fronthaul Interfaces WG)—Control, User and Synchronization Plane Specification.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for training-based CSI. In certain embodiments, one or more of the BSs 101-103 include circuitry, programing, or a combination thereof to support UCI reporting.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

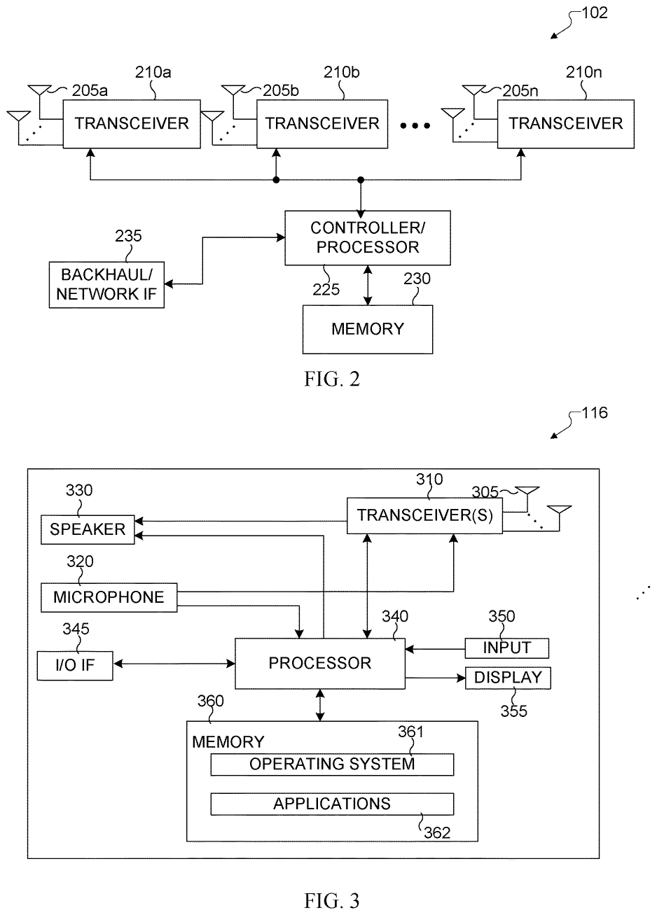

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for UCI reporting. Any of a wide variety of other functions could be supported in the gNB 102 by the controller/processor 225.

The controller/processor 225 is also capable of executing programs and other processes resident in the memory 230, such as processes to support UCI reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of uplink (UL) channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for UCI reporting as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

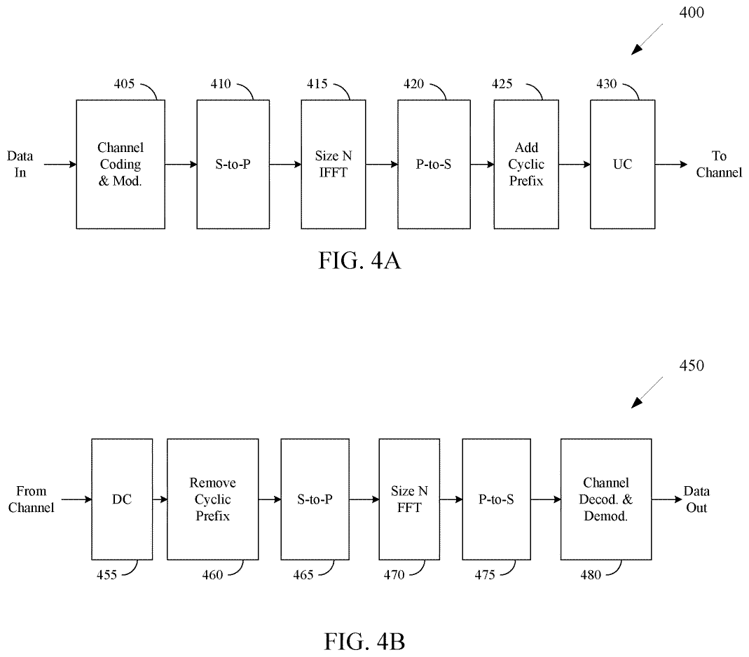

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured for UCI reporting as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted, and additional components can be added according to particular needs. Also, FIGS. 4A and 4B are meant to illustrate examples of the types of transmit and receive paths that can be used in a wireless network. Any other suitable architectures can be used to support wireless communications in a wireless network.

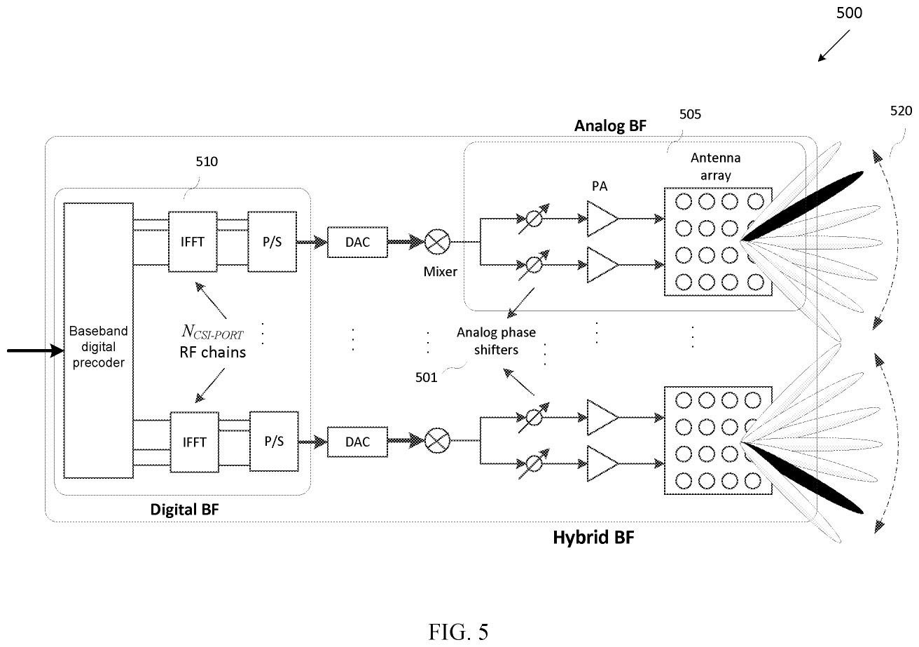

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

In a hybrid analog-digital beamforming, analog beamforming corresponds to a ‘dynamic/varying’ virtualization of multiple antenna elements to obtain one antenna port (or antenna panel). Although the number of antenna elements can be larger for a given form factor, the number of CSI-RS ports—which can correspond to the number of digitally precoded ports—can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency subbands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (~10 dB additional loss per 100 m distance), a larger number and narrower analog beams (hence a larger number of radiators in the array) are essential to compensate for the additional path loss.

Likewise, for a cellular system operating in low carrier frequency in general, a sub-1 GHz frequency range (e.g., less than 1 GHz) as an example, supporting large number of CSI-RS antenna ports (e.g., 32) or many antenna elements at a single location or remote radio head (RRH) or TRP is challenging due to a larger antenna form factor size needed evaluating carrier frequency wavelength than a system operating at a higher frequency such as 2 GHz or 4 GHz. At such low frequencies, the maximum number of CSI-RS antenna ports that can be co-located at a site (or RRH or TRP) can be limited, for example to 8. This limits the spectral efficiency of such systems. In particular, the multiple user multiple-input-multiple-output (MU-MIMO) spatial multiplexing gains offered due to large number of CSI-RS antenna ports (such as 32) can't be achieved due to the antenna form factor limitation. One plausible way to operate a system with large number of CSI-RS antenna ports at low carrier frequency is to distribute the physical antenna ports to different panels/RRHs/TRPs, which can be non-collocated. The multiple sites or panels/RRHs/TRPs can still be connected to a single (common) base unit forming a single antenna system, hence the signal transmitted/received via multiple distributed RRHs/TRPs can still be processed at a centralized location.

As described herein, for low (FR1), high (FR2 and beyond), or mid (6-15 GHz) band, the NW topology/architecture is likely to be more and more distributed in future due to reasons explained herein (e.g., use cases, HW requirements, antenna form factors, mobility etc.). In this disclosure, such a distributed system is referred to as a DMIMO or multiple TRP (mTRP) system (multiple antenna port groups, which can be non-co-located). The transmission in such a system can be coherent joint transmission (CJT), i.e., a layer can be transmitted across/using multiple TRPs, or non-coherent joint transmission (NCJT). Due to distributed nature of operation, the groups of antenna ports (or TRPs) need to be calibrated/synchronized by compensating for the non-idealities such as time/frequency/phase offsets non-ideal backhaul across TRPs, due to HW impairments, different delay profiles, and Doppler profile (in high-speed scenarios) associated with different TRPs.

In one example, a TRP or RRH can be functionally equivalent to (hence can be replaced with) or is interchangeable with one of more of the following: an antenna, or an antenna group (multiple antennae), an antenna port, an antenna port group (multiple ports), a CSI-RS resource, multiple CSI-RS resources, a CSI-RS resource set, multiple CSI-RS resource sets, an antenna panel, multiple antenna panels, a Tx-Rx entity, a (analog) beam, a (analog) beam group, a cell, a cell group.

There are two types of frequency range (FR) defined in 3GPP 5G NR specifications. The sub-6 GHz range is called frequency range 1 (FR1) and millimeter wave range is called frequency range 2 (FR2). An example of the frequency range for FR1 and FR2 is shown in Table 1. Whenever the FR2 is referred, both FR2-1 and FR2-2 frequency sub-ranges shall be provided, unless otherwise stated.

TABLE 1
Definition of frequency ranges

| | |
|---|---|
| Frequency range designation | Corresponding frequency range |

| FR1 | | 410 MHz-7125 MHz |
|---|---|---|
| FR2 | FR2-1 | 24250 MHz-52600 MHz |
| | FR2-2 | 52600 MHz-71000 MHz |

In next generation cellular standards (e.g., 6G), in addition to FR1 and FR2, new carrier frequency bands can be taken into account, e.g., terahertz (>100 GHz) and FR3 or upper mid-band (7-24 GHz). The number of antenna ports that can be supported for these new bands is likely to be different from FR1 and FR2. In particular, for 7-15 GHz band, the max number of antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (potentially non-co-located, hence geographically separated) TRPs or O-RUs within a cellular region can be the main scenario of interest, due to which the number of CSI-RS antenna ports for MIMO can be even larger (e.g., up to 256).

A (spatial or digital) precoding/beamforming can be used across these large number of antenna ports in order to achieve MIMO gains. Depending on the carrier frequency, and the feasibility of RF/HW-related components, the (spatial) precoding/beamforming can be fully digital or hybrid analog-digital. In fully digital beamforming, there can be one-to-one mapping between an antenna port and an antenna element, or a ‘static/fixed’ virtualization of multiple antenna elements to one antenna port can be used. Each antenna port can be digitally controlled. Hence, a spatial multiplexing across antenna ports is provided.

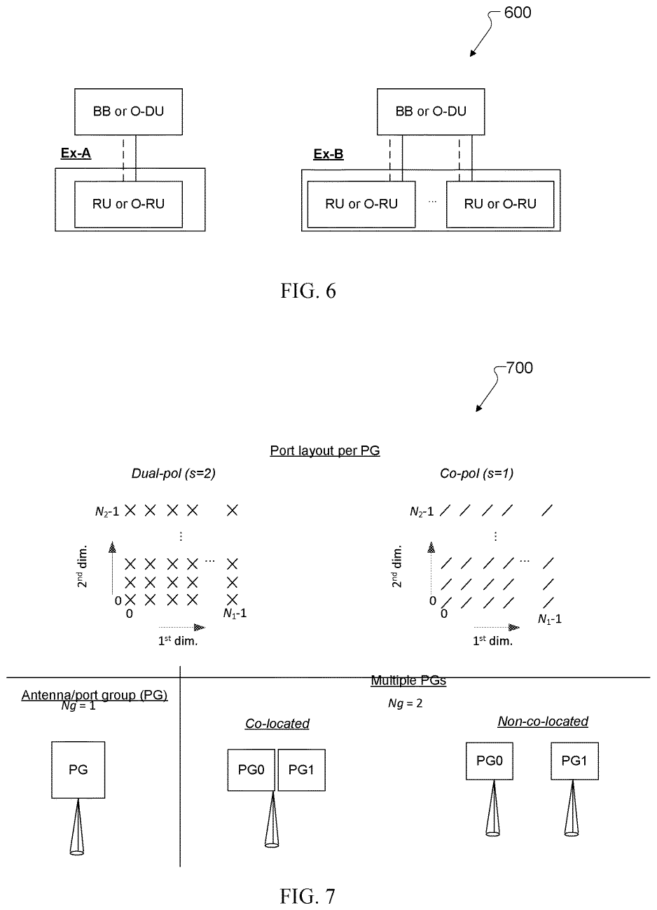

FIG. 6 illustrates a diagram of example RAN configurations 600 according to embodiments of the present disclosure. For example, RAN configurations 600 can be implemented by the BS 102 of FIG. 1. This example is for illustration only and other embodiments can be used without departing from the scope of the present disclosure.

Likewise, for O-RAN, a TRP can be functionally equivalent to (hence can be replaced with) or is interchangeable with one of more of the following:
One RU or O-RU: a logical node that includes a subset of the eNB/gNB functions (e.g., as listed in clause 4.2 split option 7-2×)
More than one RUs or O-RUs
One or more than one RUs or O-RUs

Two examples are shown in FIG. 6.

The following are defined in [REF11 and REF12].

| | |
|---|---|
| O-CU | O-RAN Central Unit - a logical node hosting PDCP, RRC, SDAP and other control |
| | functions |
| O-DU | O-RAN Distributed Unit: a logical node hosting RLC/MAC/High-PHY layers based |
| | on a lower layer functional split. O-DU in addition hosts an M-Plane instance. |
| O-RU | O-RAN Radio Unit: a logical node hosting Low-PHY layer and RF processing based |
| | on a lower layer functional split. This is similar to 3GPP's “TRP” or “RRH” but more |
| | specific in including the Low-PHY layer (FFT/iFFT, PRACH extraction). O-RU in |
| | addition hosts M-Plane instance. |

The 5th generation (5G) standard supports several features, but only a handful of them is implemented in real products. The main reason is owing to complexity, feasibility, and market need of those features. 6G should therefore be (a) aimed for realistic antenna structures, deployment scenarios, and feasibility of features, (b) simpler than 5G (to ease implementations), whenever possible (c) learning-based (for adaptability and future-proofness). Just like 5G, multiple-input multiple-output (MIMO) is expected to encompass key enabling technologies/features to meet data-rate requirements in the 6th generation (6G) as well. In particular, a codebook-based channel state information (CSI) acquisition at the network (NW) is likely to remain crucial for frequency division duplexing (FDD) as well as time division duplexing (TDD) bands in real 6G NW deployments.

The codebook-based CSI in 5G is based on a fixed-basis. In spatial domain (SD), the fixed-basis is designed assuming a structured (e.g., planar dual-polarized) antenna port layout, considering one or multiple of such layouts located at transmit-receive points (TRPs). The fixed-basis is optimized depending on deployment of these TRPs (co-located vs distributed) and transmission hypotheses, i.e., TRP selection vs non-coherent joint transmission (NCJT) vs coherent JT (CJT). For further CSI compression, the fixed-basis is extended in frequency domain (FD) and Doppler domain (DD). As many as 20 codebooks (at least one codebook per 5G release) have been specified thus far. This approach of designing codebooks is becoming untenable. Especially in 6G, the fixed-basis is quite limited in its utility due to (i) more diverse and less-structured and non-planar antenna types, e.g., reconfigurable intelligent surface (RIS), three-dimensional (3D) cylindrical/semi-spherical antenna may be used, while two-dimensional (2D) planar array is still relevant, and (ii) NW deployment/topology is expected to be more distributed due to large antenna form factor (in low band), channel-sparsity, or rank-deficiency (in higher bands), implying larger number of antenna ports (e.g., up to 256) than 5G. Considering the above, a unified future-proof design while still highly performing for key scenarios is deemed necessary. The design should be upgradable (based on parameterized components), scalable (as number of antenna ports grows or geometry or distribution evolves), and learning-based (if/when possible). A new CSI paradigm, namely artificial intelligence (AI)-native CSI provided in this disclosure can be instrumental in this regard.

A legacy up to 5G network (NW) can be described in terms of transmit-receive points (TRPs). For a first frequency range (FR1), i.e., <6 GHz, a TRP can comprise one or more antenna ports, and is fully-digital (i.e., each antenna port is driven by a dedicated baseband processing chain); and for a second frequency range 24.25-52.6 GHz (FR2), i.e., for mmWave frequencies, a TRP comprises one of more antenna panels (sub-arrays), each comprising one or two antenna ports that are controlled by analog phase shifters that result in an analog beam (pointing in certain spatial direction). An antenna port in FR1 can also be beamformed (aka virtualization); however, such a beamforming (BF) is generally static (non-adaptive, hence not requiring measurement and reporting). In FR2, due to large propagation loss at mmWave frequencies, each antenna panel requires dynamic frequent update of the analog BF, which is often based on (analog) beam measurement and reporting.

A communication between the 5G NW and a user is broadly based on: (A1) NW resources, and (A2) signaling components, where the former corresponds to spatial-domain, frequency-domain, and time-domain (SD, FD, TD) resources allocated to the user for the communication, and the latter corresponds to components that are signaled over the NW resources. The SD resources can be based on a single TRP (sTRP) or multiple TRPs (mTRP), where mTRP can be (B1) co-located at a site/location or (B2) non-co-located/distributed at multiple sites/locations, where the latter corresponds to a distributed SD resource, hence the corresponding communication hypothesis can be (C1) non-coherent joint transmission (NCJT) where a data stream (layer) is transmitted from one of the mTRPs, or (C2) coherent JT (CJT), where a data stream (layer) can be transmitted from multiple of the mTRPs. The FD resources can comprise a set of PRBs, and the TD resources can comprise one or multiple time slots (i.e., 1 slot=N_{sym} consecutive symbols).
The signaling components include signaling associated with (D1) measurement, (D2) channel state information (CSI) report, and (D3) DL reception or UL transmission.
For (D1), the user measures channel measurement RSs (CMRs) to estimate the channel condition between the sTRP/mTRP and the user. In case of sTRP, the user can measure a set comprising one or multiple DL measurement resources. For mTRP, the measurement resources can be (E1) one resource set comprising one group per TRP, or (E2) one resource set per TRP. The user can also measure the interference based on interference measurement RSs (IMRs). A CMR can correspond to an analog beam, and can be repeated in multiple symbols for determining user's analog beam.
For (D2), the user, based on the measurement, determines the CSI and reports it to the NW, where the CSI can be (F1) (analog) beam-related CSI, or (F2) (digital) non-beam-related CSI.
For (F1), the user determines one or multiple pairs (indicator, metric), where the indicator indicates a CMR and the metric indicates a (beam) quality (e.g., RSRP, SINR).
For (F2), a low-resolution (Type-I) CSI and a high-resolution (Type-II) CSI are supported. The Type-I CSI is based on L=1 DFT SD vector per layer, requires low feedback overhead and is expected to work reasonably well for single user (SU)-MIMO. For multiuser-(MU-)MIMO transmission, however, high-resolution Type II CSI capturing multiple dominant directions of the channel is essential in order to suppress inter-user interference. The Type-II CSI is based on a weighted linear combination L>1 SD DFT vectors where the weights correspond to coefficients. The FD DFT vectors were additionally introduced enhanced Type-II CSI to reduce the CSI feedback overhead by compressing channel coefficients in both SD and FD. A further enhanced Type-II port-selection (PS) CSI was specified to further reduce the CSI overhead by exploiting a reciprocity of angle-and-delay domain between uplink and downlink channels. Assuming NW performs pre-processing with beamformed CSI-RS to concentrate angle-and-delay domain components in few SD and FD basis directions, the user can be configured to select a subset of antenna ports (at a TRP) and one or two FD vectors. Additionally, a NCJT Type-I CSI was supported for up to two TRPs and multiple (sTRP or NCJT) hypotheses. Furthermore, the enhanced Type-II CSI is extended to support CJT Type-II CSI from mTRP and for high/medium user velocities exploiting time-domain correlation or Doppler-domain information, respectively.

In 5G NR, a significant improvement in throughput can be obtained by supporting MU-MIMO transmission, where one gNB simultaneously transmits multiple data streams to multiple UEs. MU-MIMO transmission relies on the availability of accurate DL CSI at the gNB; in FDD systems, each UE measures DL CSI and reports its measurements. Each CSI report can include PMI (the dominant channel directions), RI (the number of dominant channel directions), and/or CQI (the best modulation and code rate that the channel can support).

The overhead of DL CSI increases with the number of antenna ports at the gNB and the number of SBs. Current 5G systems support tens of SBs and a maximum of 32 antenna ports at the gNB. Each UE uses pre-defined codebooks (e.g., Type I and Type II) for compressing DL CSI before it is reported to the gNB. These codebooks exploit channel correlations in the spatial and frequency domains; the application of these codebooks has significantly reduced the overhead of DL CSI feedback. In Release-18, these codebooks are extended to exploit channel correlations in the temporal domain; the application of these codebooks could yield additional reductions in the overhead of DL CSI feedback.

The number of antenna ports at the gNB and the number of SBs are expected to increase for future systems to meet more stringent performance requirements—yet the overhead reduction from pre-defined codebooks may not scale accordingly (e.g., Type I and Type II codebooks utilize a DFT basis, which may not be applicable to future antenna configurations).

Besides, 5G NR codebooks (CBs) compress the CSI in the spatial/angle (introduced in Rel-15), frequency/delay (introduced in Rel-16), and time/Doppler (introduced in Rel-18) domains. The 5G NR CBs employ DFT basis vectors-based compression exploiting the sparsity of the channel (fewer significant coefficients) in certain domain (angle/delay/Doppler), DFT basis vectors-based representation of precoding vectors is computationally advantageous, e.g., O(n²) complexity for basis matrix inversion. However, basis vectors-based representation may incur a non-trivial approximation error due to incomplete basis representation, fixed basis sampling, fixed (RRC-configured) number of basis vectors, etc. An example in which the channel strength in the spatial-frequency domain and angel-delay domain for a single layer precoding vectors (32 ports and 13 subbands) is considered. Rel-16 eType II codebook exploits the sparsity of the strong angle-delay coefficients for feedback overhead reduction, i.e., e.g., reports coefficients, say, corresponding to L=4 angle (beam) per polarization and M=3 delay components (basis vectors). The components, which are still significant but not reported by the eType II-based CSI feedback, contribute to the performance (accuracy) gap from the ideal feedback.

Considering the abovementioned issues with 5G NR (DFT-based fixed) CBs, it may be advantageous to configure a UE to support alternate methods of compressing DL CSI. For instance, deep-learning or AI/ML-based CSI feedback has a potential of providing better accuracy-overhead trade-off via non-linear compression. The following are the potential benefits of AI/ML-based CSI feedback.
Better performance, i.e., CSI feedback accuracy-overhead trade-off
Antenna panels/arrangements agnostic as opposed to the limitation of NR CBs to ULA
Better flexibility to support variable CSI feedback payload size
Capability to scale with larger CSI dimensions (large number of ports, SD/FD/TD granularities, etc.)

For example, assume that an AI/ML model architecture can be designed to train an autoencoder for generating/reporting CSI feedback, where the encoder utilizes a single CNN layer. When this trained autoencoder is used for inference, applying this CNN layer is equivalent to pre-multiplying its input by a Toeplitz (or doubly-block Toeplitz, circulant, doubly-block circulant, concatenation of doubly-block Toeplitz/circulant) matrix. For example, 1-D linear convolution is equivalent to pre-multiplication by a Toeplitz matrix, while 2-D linear convolution is equivalent to pre-multiplication by a doubly-block Toeplitz matrix. Also, 1-D circular convolution is equivalent to pre-multiplication by a circulant matrix, while 2-D circular convolution is equivalent to pre-multiplication by a doubly-block circulant matrix. In addition, 3-D linear convolution is equivalent to pre-multiplication by a matrix that consists of a concatenation of doubly-block Toeplitz matrices [8].

For a single layer CNN, the Kernel is a vector/matrix (e.g., a vector if learning/training is only SD, and a matrix if it is on both SD and FD). The convolution is equivalent to the following:
Create column vector from input H, i.e., h
a=W*h (where W is a Kernel matrix/vector based on doubly-block Toeplitz)
   Zero-pad kernel to create W
Reshape a to matrix A
   For each row in A, discard all entries from partial kernel overlap with H

The W is essentially a Toeplitz matrix when the Kernel is a vector, and a doubly Toeplitz matrix when the Kernel is a matrix. A Toeplitz matrix [5] has constant (same) values along its negative-sloping diagonals; an example is shown in (1) as values . . . , a₋₁, a₀, a₁, . . . .

$$A = [ \begin{matrix}{a}_{0} & {a}_{- 1} & {a}_{- 2} & … & {a}_{- n + 1} \\ {a}_{1} & {a}_{0} & {a}_{- 1} & ⋱ & ⋮ \\ {a}_{2} & {a}_{1} & {a}_{0} & ⋱ & {a}_{- 2} \\ ⋮ & ⋱ & ⋱ & ⋱ & {a}_{- 1} \\ {a}_{n - 1} & … & {a}_{2} & {a}_{1} & {a}_{0}\end{matrix} ] \qquad ( 1 )$$

A doubly-block Toeplitz matrix [6] is a block matrix R where 1) its (i,j)-th block Riu is a function of i-j (thus, it can be denoted by Rᵢ₋ⱼ) and 2) Rᵢⱼ (denoted by Rᵢ₋ⱼ) is itself a Toeplitz matrix. An example is shown in (2), where each Rⱼ is a Toeplitz matrix.

$$R = [ \begin{matrix}{R}_{0} & {R}_{- 1} & {R}_{- 2} & … & {R}_{- n + 1} \\ {R}_{1} & {R}_{0} & {R}_{- 1} & ⋱ & ⋮ \\ {R}_{2} & {R}_{1} & {R}_{0} & ⋱ & {R}_{- 2} \\ ⋮ & ⋱ & ⋱ & ⋱ & {R}_{- 1} \\ {R}_{n - 1} & … & {R}_{2} & {R}_{1} & {R}_{0}\end{matrix} ] \qquad ( 2 )$$

A circulant matrix [7] is a special case of a Toeplitz matrix where each row (column) is a circular shift of the previous row (column). An example is shown in (3).

$$A = [ \begin{matrix}{a}_{0} & {a}_{- 1} & {a}_{- 2} & … & {a}_{- n + 1} \\ {a}_{- n + 1} & {a}_{0} & {a}_{- 1} & ⋱ & {a}_{- n + 2} \\ {a}_{- n + 2} & {a}_{- n + 1} & {a}_{0} & ⋱ & {a}_{- n + 3} \\ ⋮ & ⋱ & ⋱ & ⋱ & ⋮ \\ {a}_{- 1} & … & {a}_{- n + 2} & {a}_{- n + 1} & {a}_{0}\end{matrix} ] \qquad ( 3 )$$

A doubly-block circulant matrix is a special case of a doubly-block Toeplitz matrix R where 1) each block row (column) is a circular shift of the previous block row (column) and 2) its (i,j)-th block Rᵢⱼ (denoted by Rᵢ₋ⱼ) is itself a circulant matrix. An example is shown in (4), where each Rⱼ is a circulant matrix.

$$R = [ \begin{matrix}{R}_{0} & {R}_{- 1} & {R}_{- 2} & … & {R}_{- n + 1} \\ {R}_{- n + 1} & {R}_{0} & {R}_{- 1} & ⋱ & {R}_{- n + 2} \\ {R}_{n - + 2} & {R}_{- n + 1} & {R}_{0} & ⋱ & {R}_{- n + 3} \\ ⋮ & ⋱ & ⋱ & ⋱ & ⋮ \\ {R}_{- 1} & … & {R}_{- n + 2} & {R}_{- n + 1} & {R}_{0}\end{matrix} ] \qquad ( 4 )$$

Thus, using this trained autoencoder for inference is equivalent to applying a Toeplitz-based method for generating/reporting CSI feedback. This Toeplitz-based method can utilize a flexible basis that depends on a training dataset.

Embodiments of the present disclosure recognize that the 5G CSI is based on a fixed-basis codebook. The fixed-basis approach is unscalable and non-future-proof, since it requires specific designs tailored for CSI compression/resolution type, deployment scenario, transmission hypothesis, and operating carrier frequency, as is evident from close to two dozen codebooks specified in 5G. AI-native is expected to be an integral part of a 6G system, hence can be instrumental in designing a scenario-driven learning-based basis, whenever feasible, as a replacement for the fixed-basis.

Accordingly, embodiments of the present disclosure describe several examples for learning-based (aka AI-native) CSI. Details on the support of these methods for generating/reporting CSI are disclosed, including information elements to be exchanged between a transmitter and a receiver. The following aspects are described in the disclosure:
UCI parameters
UCI partitioning

In the following, for brevity, both FDD and TDD are regarded as the duplex method for both DL and UL signaling.

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure covers several components which can be used in conjunction or in combination with one another, or can operate as standalone schemes.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, the following components and embodiments are applicable for UL transmission when the scheduling unit in time is either one subframe (which can include one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” or bandwidth part (BWP) can also be used.

In terms of UE configuration, a UE (e.g., the UE 116) can be configured with at least one CSI reporting band. This configuration can be semi-static (via higher-layer signaling or RRC) or dynamic (via MAC CE or L1 DL control signaling). When configured with multiple (N) CSI reporting bands (e.g., via RRC signaling), a UE can report CSI associated with n≤N CSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mₙ subbands when one CSI parameter for the Mₙ subbands within the CSI reporting band. A CSI parameter is configured with “subband” for the CSI reporting band with Mₙ subbands when one CSI parameter is reported for each of the Mₙ subbands within the CSI reporting band.

FIG. 7 illustrates an example antenna port layout 700 according to embodiments of the present disclosure. For example, antenna port layout 700 can be implemented in the wireless network 100 of FIG. 1. This example is for illustration only and can be used without departing from the scope of the present disclosure.

In the following, N₁ and N₂ are the number of antenna ports with the same polarization in the first and second dimensions, respectively. For 2D antenna port layouts, N₁>1, N₂>1, and for 1D antenna port layouts either have N₁>1 and N₂=1 or N₂>1 and N₁=1. In the rest of the disclosure, 1D antenna port layouts with N₁>1 and N₂=1 is taken into account. The disclosure, however, is applicable to the other 1D port layouts with N₂>1 and N₁=1. Also, in the rest of the disclosure, N₁≥N₂. The disclosure, however, is applicable to the case when N₁<N₂, and the embodiments for N₁>N₂ apply to the case N₁<N₂ by swapping/switching (N₁, N₂) with (N₂, N₁). For a single-polarized (or co-polarized) antenna port layout, the total number of antenna ports is P_{CSIRS}=N₁N₂. And, for a dual-polarized antenna port layout, the total number of antenna ports is P_{CSIRS}=2N₁N₂. An illustration is shown in FIG. 7 where “X” represents two antenna polarizations (dual-pol, s=2) and “/” represents one antenna polarization (co-pol, s=1). In this disclosure, the term “polarization” refers to a group of antenna ports with the same polarization. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-RS antenna ports and X is a starting antenna port number (e.g., X=3000, then antenna ports are 3000, 3001, 3002, . . . ). Unless stated otherwise, dual-polarized antenna layouts are expected in this disclosure. The embodiments (and examples) in this disclosure however are general and are applicable to single-polarized antenna layouts as well.

Let s denotes the number of antenna polarizations (or groups of antenna ports with the same polarization). Then, for co-polarized antenna ports, s=1, and for dual- or cross (X)-polarized antenna ports s=2. So, the total number of antenna ports P_{CSIRS}=sN₁N₂.

Let N_{g} be a number of antenna/port groups (PGs). When there are multiple antenna/port groups (N_{g}>1), each group (g∈{1, . . . , N_{g}}) comprises N_{1,g} and N_{2,g} ports in two dimensions. This is illustrated in FIG. 7. Note that the antenna port layouts may be the same (N_{1,g}=N₁ and N_{2,g}=N₂) in different antenna/port groups, or they can be different across antenna/port groups. For group g, the number of antenna ports is P_{CSIRS,g}=N_{1,g}N_{2,g} or 2N_{1,g}N_{2,g} (for co-polarized or dual-polarized respectively), i.e., P_{CSIRS,g}=s_{g}N_{1,g},N_{2,g} where s_{g}=1 or 2.

In one example, an antenna/port group corresponds to an antenna panel. In one example, an antenna/port group corresponds to a TRP. In one example, an antenna/port group corresponds to an RRH. In one example, an antenna/port group corresponds to CSI-RS antenna ports of a NZP CSI-RS resource. In one example, an antenna/port group corresponds to a subset of CSI-RS antenna ports of a NZP CSI-RS resource (comprising multiple antenna/port groups). In one example, an antenna/port group corresponds to CSI-RS antenna ports of multiple NZP CSI-RS resources (e.g., comprising a CSI-RS resource set).

In one example, an antenna/port group corresponds to a reconfigurable intelligent surface (RIS) in which the antenna/port group can be (re-)configured more dynamically (e.g., via MAC CE or/and downlink control information (DCI)). For example, the number of antenna ports associated with the antenna/port group can be changed dynamically.

In one example, the antenna architecture of the MIMO system is structured. For example, the antenna structure at each PG or O-RU (or RU) is dual-polarized (single or multi-panel as shown in FIG. 7. The antenna structure at each PG or O-RU (or RU) can be the same. Or the antenna structure at an PG or O-RU (or RU) can be different from another PG or O-RU (or RU). Likewise, the number of ports at each PG (OR O-RU OR RU) can be the same. Or the number of ports at one PG (OR O-RU OR RU) can be different from another PG (OR O-RU OR RU).

In another example, the antenna architecture of the MIMO system is unstructured. For example, the antenna structure at one PG (OR O-RU OR RU) can be different from another PG (OR O-RU OR RU).

A structured antenna architecture is provided in the rest of the disclosure. For simplicity, each PG (OR O-RU OR RU) is equivalent to a panel (cf. FIG. 7), although, an PG (OR O-RU OR RU) can have multiple panels in practice. The disclosure however is not restrictive to a single panel expectation at each PG (OR O-RU OR RU), and can easily be extended (covers) the case when an PG (OR O-RU OR RU) has multiple antenna panels.

In one embodiment, an PG (OR O-RU OR RU) constitutes (or corresponds to or is equivalent to) at least one of the following:
In one example, an PG OR O-RU (OR RU) corresponds to a TRP.
In one example, an PG or O-RU (or RU) corresponds to a CSI-RS resource. A UE is configured with K=N_{g}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained in this disclosure herein.
In one example, an PG or O-RU (or RU) corresponds to a CSI-RS resource group, where a group comprises one or multiple NZP CSI-RS resources. A UE is configured with K≥N_{g}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained in this disclosure herein. In particular, the K CSI-RS resources can be partitioned into N_{g} resource groups. The information about the resource grouping can be provided together with the CSI-RS resource setting/configuration, or with the CSI reporting setting/configuration, or with the CSI-RS resource configuration.
In one example, an PG or O-RU (or RU) corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an PG or O-RU (or RU). The information about the subsets of ports or grouping of ports can be provided together with the CSI-RS resource setting/configuration, or with the CSI reporting setting/configuration, or with the CSI-RS resource configuration.
In one example, an PG or O-RU (or RU) corresponds to one or more examples described herein depending on a configuration. For example, this configuration can be explicit via a parameter (e.g., an RRC parameter). Or it can be implicit.
   In one example, when implicit, it could be based on the value of K. For example, when K>1 CSI-RS resources, an PG or O-RU (or RU) corresponds to one or more examples described herein, and when K=1 CSI-RS resource, an PG or O-RU (or RU) corresponds to one or more examples described herein.
   In another example, the configuration could be based on the configured codebook. For example, an PG or O-RU (or RU) corresponds to a CSI-RS resource (according to one or more examples described herein) or resource group (according to one or more examples described herein) when the codebook corresponds to a decoupled codebook (modular or separate codebook for each PG or O-RU (or RU)), and an PG or O-RU (or RU) corresponds to a subset (or a group) of CSI-RS ports (according to one or more examples described herein) when codebook corresponds to a coupled (joint or coherent) codebook (one joint codebook across PGs).

In one example, when PG or O-RU (or RU) maps (or corresponds to) a CSI-RS resource or resource group (according to one or more examples described herein), and a UE can select a subset of PGs (resources or resource groups) and report the CSI for the selected PGs (resources or resource groups), the selected PGs can be reported via an indicator. For example, the indicator can be a CQI report interval (CRI) or a PMI (component) or a new indicator.

In one example, when PG or O-RU (or RU) maps (or corresponds to) a CSI-RS port group (according to one or more examples described herein), and a UE can select a subset of PGs (port groups) and report the CSI for the selected PGs (port groups), the selected PGs can be reported via an indicator. For example, the indicator can be a CRI or a PMI (component) or a new indicator.

In one example, when multiple (K>1) CSI-RS resources are configured for N_{g} PGs (according to one or more examples described herein), a decoupled (modular) codebook is used/configured, and when a single (K=1) CSI-RS resource for N_{g} PGs (according to one or more examples described herein), a joint codebook is used/configured.

In one embodiment, a UE is configured (e.g., via a higher layer CSI configuration information) with a CSI report, where the CSI report is based on a channel measurement (and interference measurement) and a codebook. When the CSI report is configured to be aperiodic, it is reported when triggered via a DCI field (e.g., a CSI request field) in a DCI.

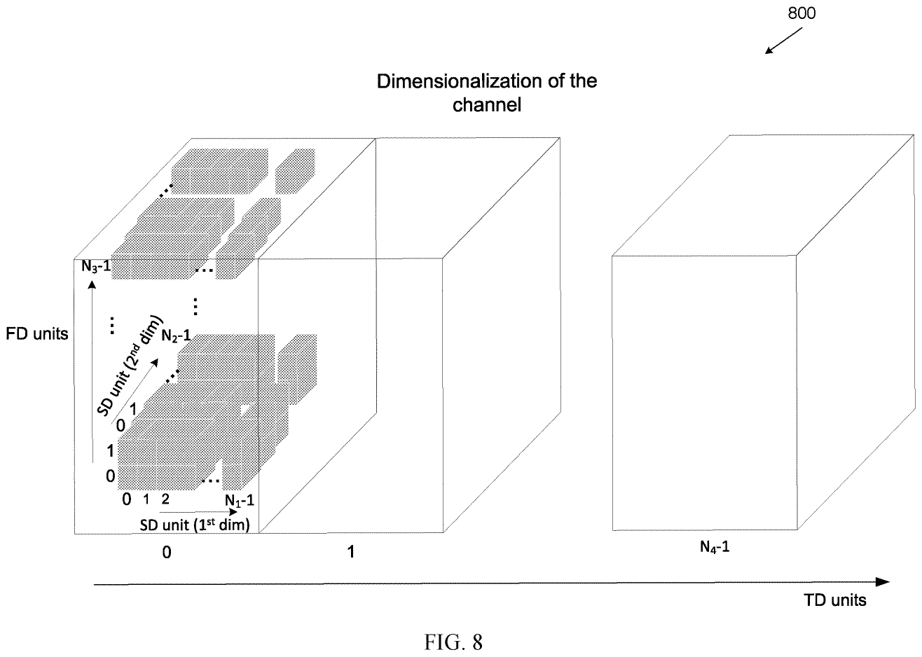

FIG. 8 illustrates a timeline 800 of example SD units and FD units according to embodiments of the present disclosure. For example, timeline 800 can be followed by any of the UEs 111-116 of FIG. 1, such as the UE 116. This example is for illustration only and other embodiments can be used without departing from the scope of the present disclosure.

The channel measurement can be based on K≥1 channel measurement resources (CMRs) that are transmitted from a plurality of spatial-domain (SD) units (e.g., a SD unit=a CSI-RS antenna port), and are measured via a plurality of frequency-domain (FD) units (e.g., a FD unit=one or more PRBs/SBs) and via either a time-domain (TD) unit or a plurality of TD units (e.g., a TD unit=one or more time slots). In one example, a CMR can be a NZP-CSI-RS resource.

The CSI report can be associated with the plurality of FD units and the plurality of TD units associated with the channel measurement. Alternatively, the CSI report can be associated with a second set of FD units (different from the plurality of FD units associated with the channel measurement) or/and a second set of TD units (different from the plurality of TD units associated with the channel measurement). In this later case, the UE, based on the channel measurement, can perform prediction (interpolation or extrapolation) in the second set of FD units or/and the second set of TD units associated with the CSI report.

An illustration of the SD units (in 1^{st} and 2^{nd} antenna dimensions), FD units, and, and TD units is shown in FIG. 8.
The first dimension is associated with the 1st antenna port dimension and comprises N₁ units,
The second dimension is associated with the 2nd antenna port dimension and comprises N₂ units,
The third dimension is associated with the frequency dimension and comprises N₃ units, and
The fourth dimension is associated with the time/Doppler dimension and comprises N₄ units.

Alternatively, the SD units, FD units, and TD units are as follows.
The first dimension is associated with the antenna port dimension and comprises P_{CSIRS} units,
The second dimension is associated with the frequency dimension and comprises N₃ units, and
The third dimension is associated with the time/Doppler dimension and comprises N₄ units.

The plurality of SD units can be associated with antenna ports (e.g., co-located at one site or distributed across multiple sites) comprising one or multiple antenna/port groups (i.e., N_{g}≥1), and dimensionalizes the spatial-domain profile of the channel measurement.

When K=1, there is one CMR comprising P_{CSIRS} CSI-RS antenna ports.
When N_{g}=1, there is one PG or O-RU (or RU) comprising P_{CSIRS} ports, and the CSI report is based on the channel measurement from the one PG or O-RU (or RU).
When N_{g}>1, there are multiple PGs, and the CSI report is based on the channel measurement from/across the multiple PGs.

When K>1, there are multiple CMRs, and the CSI report is based on the channel measurement across the multiple CMRs. In one example, a CMR corresponds to an PG or O-RU (or RU) (one-to-one mapping). In one example, multiple CMRs can correspond to an PG or O-RU (or RU) (many-to-one mapping).

In one example, when all of the P_{CSIRS} antenna ports are co-located at one site, N_{g}=1. In one example, when all of the P_{CSIRS} antenna ports are distributed (non-co-located) across multiple sites, N_{g}>1.

In one example, when all of the P_{CSIRS} antenna ports are co-located at one site and within a single antenna panel, N_{g}=1. In one example, when all of the P_{CSIRS} antenna ports are distributed across multiple antenna panels (can be co-located or non-co-located), N_{g}>1.

The value of N_{g} can be configured, e.g., via higher layer RRC parameter. Or, it can be indicated via a MAC CE. Or, it can be provided via a DCI field.

Likewise, the value of K can be configured, e.g., via higher layer RRC parameter. Or, it can be indicated via a MAC CE. Or, it can be provided via a DCI field.

In one example, K=N_{g}=X. The value of X can be configured, e.g., via higher layer RRC parameter. Or, it can be indicated via a MAC CE. Or, it can be provided via a DCI field.

In one example, the value of K is determined based on the value of N_{g}. In one example, the value of N_{g} is determined based on the value of K.

The plurality of FD units can be associated with a frequency domain allocation of resources (e.g., one or multiple CSI reporting bands, each comprising multiple PRBs) and dimensionalizes the frequency (or delay)-domain profile of the channel measurement.

The plurality of TD units can be associated with a time domain allocation of resources (e.g., one or multiple CSI reporting windows, each comprising multiple time slots) and dimensionalizes the time (or Doppler)-domain profile of the channel measurement.

In one example, the number of antenna ports across K CSI-RS resources is the same. For example, each of the K CSI-RS resources can be associated with 2N₁N₂ antenna ports. In this case, the total number of antenna ports is P_{CSIRS,tot}=2KN₁N₂.

In one example, the number of antenna ports across K CSI-RS resources can be the same or different. For example, each of the K CSI-RS resources can be associated with ²N_{1,r}N_{2,r} antenna ports. In this case, the total number of antenna ports is

$${P}_{CSIRS , tot} = {\sum }_{r = 1}^{K} 2 {N}_{1 , r} {N}_{2 , r} .$$

In port numbering scheme 1, the CSI-RS ports are numbered according to the order of (polarization p, NZP CSI-RS resource r) as CSI-RS ports of (p=0, r=1) followed by CSI-RS ports of (p=1,r=1), followed by CSI-RS ports of (p=0,r=2), followed by CSI-RS ports of (p=1,r=2), . . . , followed by CSI-RS ports of (p=0, r=N) followed by CSI-RS ports of (p=1,r=N).

In port numbering scheme 2, the CSI-RS ports are numbered according to the order of (polarization p, NZP CSI-RS resource r) as
CSI-RS ports of (p=0, r=1) followed by CSI-RS ports of (p=0, r=1), . . . , followed by CSI-RS ports of (p=0, r=N), and
then CSI-RS ports of (p=1, r=1) followed by CSI-RS ports of (p=1, r=1), . . . , followed by CSI-RS ports of (p=1, r=N).

In one example, a PG corresponds to an antenna, an antenna group (multiple antennae), an antenna port, an antenna port group (multiple ports), a CSI-RS resource, a CSI-RS resource set, a group of CSI-RS resources, a panel, an RRH, a Tx-Rx entity, a (analog) beam, a (analog) beam group, a cell, a cell group.

In one example, PGs can have a uniform (the same/common) structure. For example, they can have the same number of ports (P_{CSIRS,r}=P_{CSIRS}) or the same antenna port layout (N_{1,r}, N_{2,r})=(N₁, N₂). In one example, PGs can have non-uniform (or different) structure. For example, they can have the same or different number of ports (P_{CSIRS,r}_{₁}=P_{CSIRS,r}_{₂} or P_{CSIRS,r}_{₁}≠P_{CSIRS,r}_{₂}) or the same antenna port layout, i.e., (N_{1,r}_{₁}, N_{2,r}_{₁})=(N_{1,r}_{₂}, N_{2,r}_{₂}) or (N_{1,r}_{₁}, N_{2,r}_{₁})≠(N_{1,r}_{₂}, N_{2,r}_{₂}).

In the present disclosure, antenna port layout, TRP and open radio unit (O-RU) are used interchangeably.

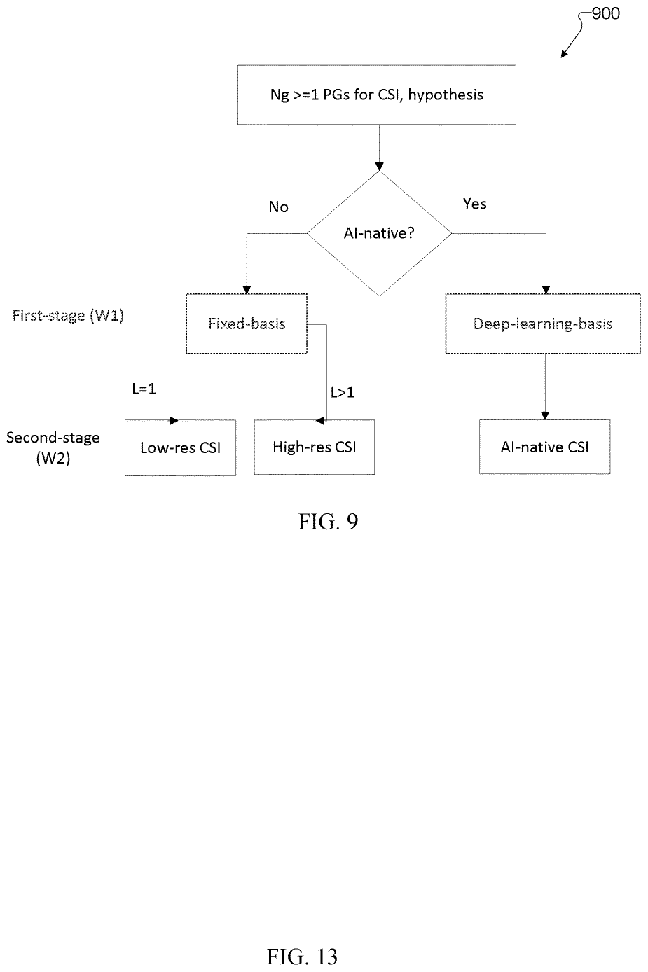

FIG. 9 illustrates an example codebook 900 according to embodiments of the present disclosure. For example, codebook 900 can be utilized by any of the UEs 111-116 of FIG. 1, such as the UE 112. This example is for illustration only and other embodiments can be used without departing from the scope of the present disclosure.

As discussed herein, a fixed codebook (expecting a uniform array and phase wave-front) is no longer sufficient in 6G due to (1) ‘new’ antenna types/architectures/geometries, (2) distributed (e.g., CJT), open (e.g., O-RAN), and “less”-structured (e.g., dynamic port adaptation for energy saving) NW topology, (3) dynamic duplexing (e.g., subband full duplex (SBFD), single frequency full duplex (SFFD)) operations, and advanced technologies such as RIS and near-field effects, and (4) new frequency bands with sparser (low-rank) channels (e.g., FR3) requiring mTRP-like MIMO operations. These necessitate a scenario-driven learning-based codebook-design. AI-native could be instrumental in this regard. For a UE not capable of AI-native, the fixed-basis codebook can be used as a last resort as illustrated in FIG. 9.

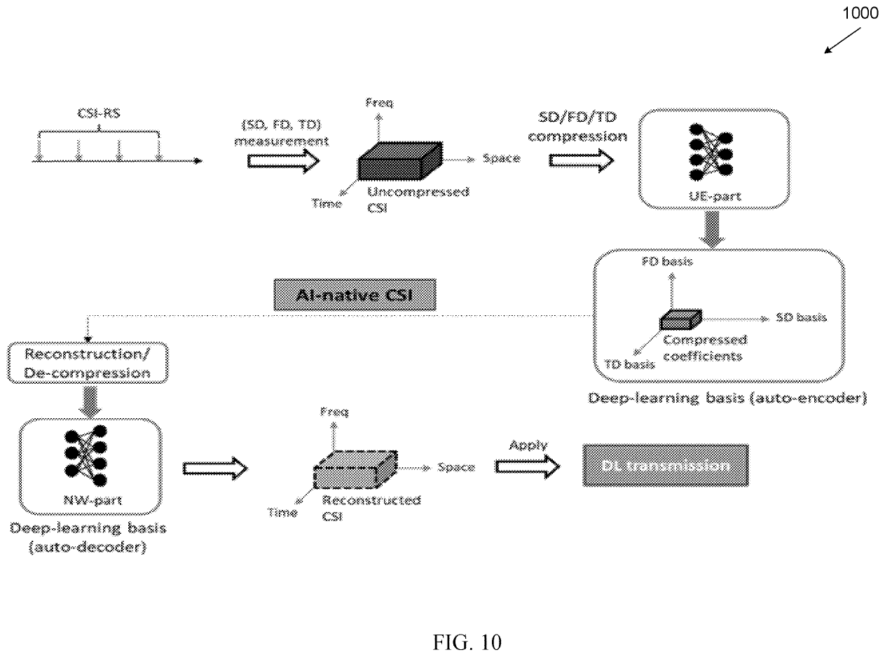

FIG. 10 illustrates an example AI-native CSI configuration 1000 according to embodiments of the present disclosure. For example, the UE 113 and the network 130 and/or the BS 103 of FIG. 1 can implement AI-native CSI configuration 1000. This example is for illustration only and other embodiments can be used without departing from the scope of the present disclosure.

In an example of AI-native CSI, the precoding is based on two stages: (i) first-stage for basis (W1) and (ii) second-stage for coefficients (W2). The first-stage includes a deep-learning-based basis, if the user is AI-native capable, and a unified fixed-basis, otherwise. The fixed-basis can also be used for fallback, initialization. An illustration of the AI-native CSI is shown in FIG. 10. The user measures CSI-RS and uses the measurement to determine uncompressed CSI. The CSI is then compressed in (SD, FD) or (SD, FD, DD), if DD compression is ON, utilizing the deep-learning-basis (auto-encoder). The compressed coefficients are then fed back as part of the AI-native CSI report. The deep-learning auto-decoder is then used to de-compress or reconstruct the CSI, which then is applied to subsequent downlink (DL) transmissions. The details of fixed- and deep-learning bases are provided next.

In one example, a unified fixed-basis can be based on a “parameterized” codebook based on parameters (L, M, Q) associated with (SD, FD, DD) bases. When L=1, the codebook operates in a low-resolution (low-res) mode based on a single SD vector (per layer), and when L>1, the codebook corresponds to a high-resolution (high-res) mode based on a linear combination of multiple SD vectors (per layer). When M is not configured, there is no FD compression, hence the coefficients are reported for each SB in the CSI reporting band. When M is configured, there is FD compression (cf. Rel-16 eType II codebook in 5G). Likewise, when Q=1, there is no DD basis, i.e., DD compression is turned OFF. When Q>1, there is DD compression across DD units (cf. Rel-18 eType II-Doppler codebook in 5G). For multiple layers, each layer is encoded independently. In low-resolution mode, there is no compression in FD and DD. The structure of the reported high-res precoders (representing channel eigenvectors) is given by a summation:

$$( DD compression ON ) : p = {\sum }_{i = 0}^{L - 1} {\sum }_{f = 0}^{M - 1} {\sum }_{d = 0}^{Q - 1} {B}_{i , f , d} {c}_{i , f , d} ,$$

$$( DD compression OFF ) : p = {\sum }_{i = 0}^{L - 1} {\sum }_{f = 0}^{M - 1} {B}_{i , f} {c}_{i , f} ,$$

where B_{i,f,d} indicates a (i, f, d)-th element of the basis in three dimensions, and c_{i,f,d} is the corresponding coefficient. For basis, orthogonal DFT vectors are used. The Rel-16 W2 quantization is used for coefficient reporting in high-res mode. The low-res precoder is given by

$$p = {\sum }_{i = 0}^{L - 1} {B}_{i} \times {c}_{i} ,$$

where Bᵢ indicates an i-th element of the SD basis, and cᵢ is the co-phasing coefficient.

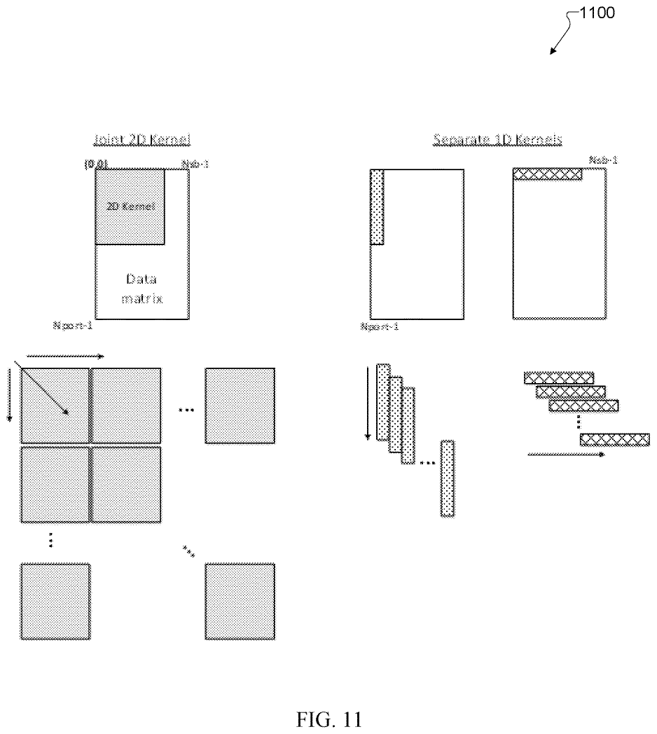

FIG. 11 illustrates an example convolution operation 1100 according to embodiments of the present disclosure. For example, convolution operation 1100 can be utilized by any of the UEs 111-116 of FIG. 1, such as the UE 116. This example is for illustration only and other embodiments can be used without departing from the scope of the present disclosure.

As antenna geometries get less-structured or more-distributed, (SD, FD, TD) properties can no longer be quantified with only fixed-basis, they rather need to be learnt depending on scenarios and deployments. Here, (SD, FD, TD) properties include antenna geometry, compression dimensions, SD/FD/TD units, prediction, and second order channel statistics. One can adopt a learning-based, e.g., a convolutional (CNN)-based deep-learning basis replacing the fixed-basis. Mathematically, a one-dimensional (1D) convolution operation is equivalent to: A=KH_{data}, where K is a Toeplitz matrix and H_{data} is a data matrix, e.g., channel eigenvector matrix with columns being eigenvectors for N_{SB} SBs. For 2D (e.g., SD and FD), we can have two separate 1D convolutions, one for each dimension, or a joint 2D convolution, as shown in FIG. 11. Two separate 1D convolutions is equivalent to:

$$A = {K}_{S D}^{H} {H}_{data} {K}_{F D} ,$$

where K_{SD} and K_{FD} are Toeplitz matrices for SD and FD, respectively. Embodiments of the present disclosure provided to use a single convolutional layer in order to keep the user complexity low. Also, a convolution operation can be based on a “full” (i.e., only full Toeplitz matrix is used) or “partial” (i.e., submatrices of the full Toeplitz matrix are also used in addition to the full matrix), where the partial kernels can be utilized to learn features around edges. The matrix K or matrices (K_{SD}, K_{FD}) are constructed based on a Kernel (basis) B.

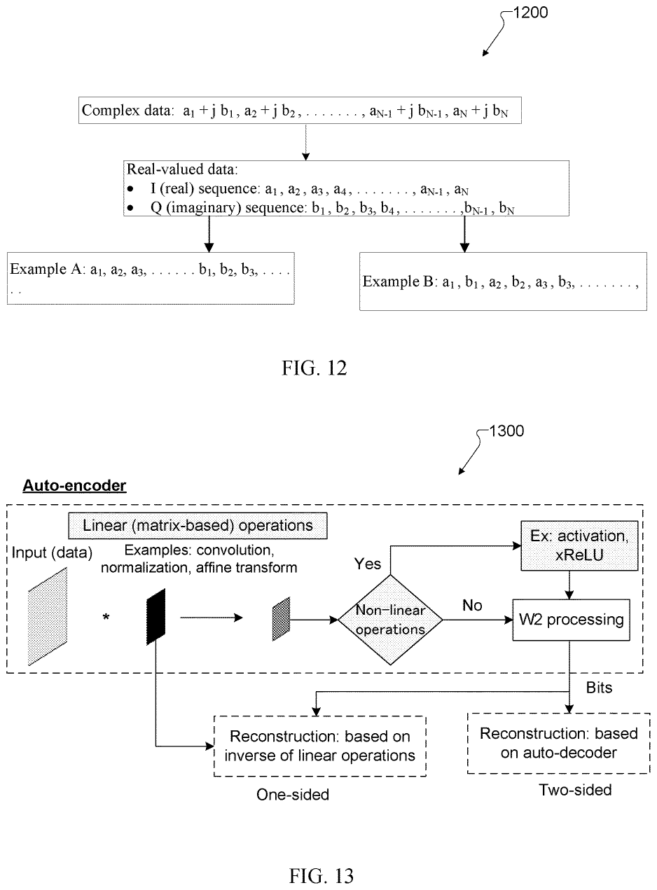

FIG. 12 illustrates an example complex-values matrix/vector 1200 according to embodiments of the present disclosure. For example, complex-values matrix/vector 1200 can be utilized by any of the UEs 111-116 of FIG. 1, such as the UE 116. This example is for illustration only and other embodiments can be used without departing from the scope of the present disclosure.

In one example, the input X is a complex-valued matrix (or vector). In one example, the input X is a real-valued matrix (or vector), which is formed by concatenation of real and imaginary parts of complex data values. At least one of the following examples shown in FIG. 12 is used for the concatenation.

FIG. 13 illustrates an example neural network based auto encoder 1300 according to embodiments of the present disclosure. For example, the UE 116 of FIG. 3 can be configured to use the neural network based auto encoder 1300. This example is for illustration only and other embodiments can be used without departing from the scope of the present disclosure.

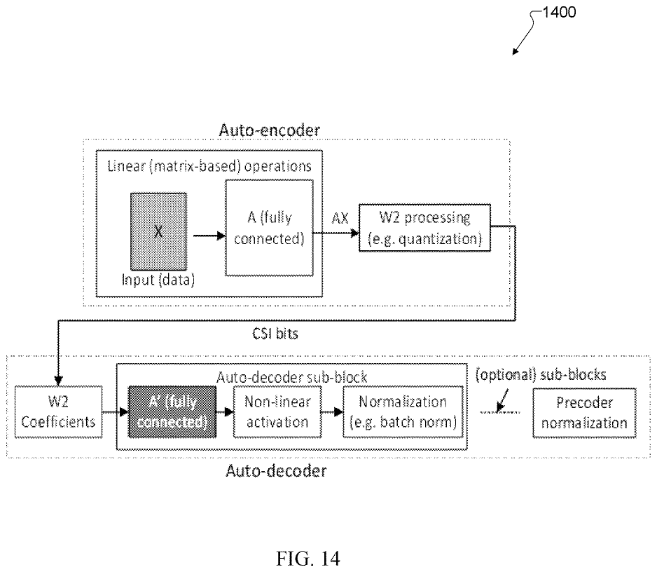

FIG. 14 illustrates an example neural network based linear auto encoder 1400 according to embodiments of the present disclosure. For example, the UE 116 of FIG. 3 can be configured to use the neural network based linear auto encoder 1400. This example is for illustration only and other embodiments can be used without departing from the scope of the present disclosure.

In one embodiment, as shown in FIG. 13, a UE (e.g., the UE 116) is configured to use a neural network (NN)-based auto-encoder (AE) model to determine a CSI, where the CSI is based on compression in at least one of SD, FD, and DD. The AE takes an input (data), e.g., eigenvectors of DL channel measurements (via CSI-RS) or DL channel estimate itself, performs operations (linear or/and non-linear) and outputs a bit sequence which is transmitted by the UE as part of the CSI report. The bit sequence is used by the NW to reconstruct the CSI. Another example of a linear auto-encoder is shown in FIG. 14.

In one embodiment, the model for CSI compression is one-sided, i.e., AE only. That is, there is no associated NN-based auto-decoder (AD) needed at the gNB (e.g., the BS 102) to reconstruct the CSI. In one example, the one-sided model is downloadable, hence can be referred to as a downloadable codebook.

In one embodiment, as shown in FIG. 14, a UE is configured to use a neural network (NN)-based two-sided model comprising an auto-encoder (AE) part and an auto-decoder (AD) part. The AE part of the model is used to determine a CSI, where the CSI is based on compression in at least one of SD, FD, and DD. The AE takes an input (data), e.g., eigenvectors of DL channel measurements (via CSI-RS) or DL channel estimate itself, performs operations (linear or/and non-linear) and outputs a bit sequence which is transmitted by the UE as part of the CSI report. The bit sequence is used by the NW as input to the AD part of the model. The output of the AD part corresponds to a reconstructed CSI.

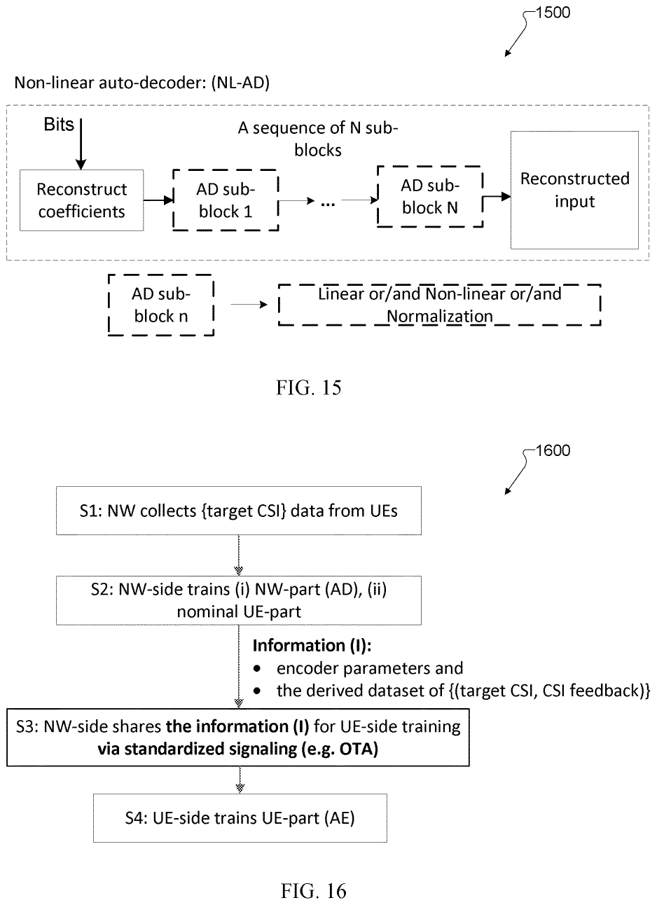

FIG. 15 illustrates an example neural network based non-linear auto decoder according to embodiments of the present disclosure. For example, the UE 116 of FIG. 3 can be configured to use the neural network based auto decoder 1500. This example is for illustration only and other embodiments can be used without departing from the scope of the present disclosure.

In one embodiment, as shown in FIG. 15, the AD-part of the two-sided model can include N>1 sub-blocks n=1, . . . , N, each comprising at least one of linear, non-linear, and normalization layers in any order. Each sub-block is according to at least one of linear, non-linear, and normalization layers.

FIG. 16 illustrates an example two-sided model procedure 1600 according to embodiments of the present disclosure. For example, the UE 116 of FIG. 3 can be configured to use the two-sided model procedure 1600. This example is for illustration only and other embodiments can be used without departing from the scope of the present disclosure.

In one embodiment, the two-sided model procedure is as shown in FIG. 16. In step S1, the NW-side collects a dataset comprising target CSI (e.g., eigenvectors or channel measurements determined based on NZP CSI-RS measurements). The dataset can be acquired at the NW based on the CSI report from the UE, or via a dedicated channel from an entity to the NW. The entity can be an OTT (over-the-top) server or an O-DU or a O-CU or O-RU or an entity in a protocol stack. In step S2, the NW-side trains the AD-part of the two-sided model assuming a reference nominal AE-part (at the UE) of a reference two-sided model. After (based on) the AD model training, the NW transfers an information (I) to a UE. The information (I) can include (i) parameter(s) of the AE-part of the two-sided model, or/and (ii) a ‘derived’ dataset for the UE-side to use for inference/training based on the AE-part. The ‘derived’ dataset can be a set of pairs {(target CSI, CSI feedback)} where the CSI feedback is the output of the nominal AE model assumed while training the AD-part. Based on the received information (I), the UE-side trains the AE-part of the two-sided model. This training can assume a reference nominal AD-part (at the NW) of a reference two-sided model. The model training at the NW or the UE can be on online (on device or on NW) or offline (e.g., via a respective OTT (over-the-top) server of UE or NW, or an O-DU or a O-CU or O-RU or an entity in a protocol stack).

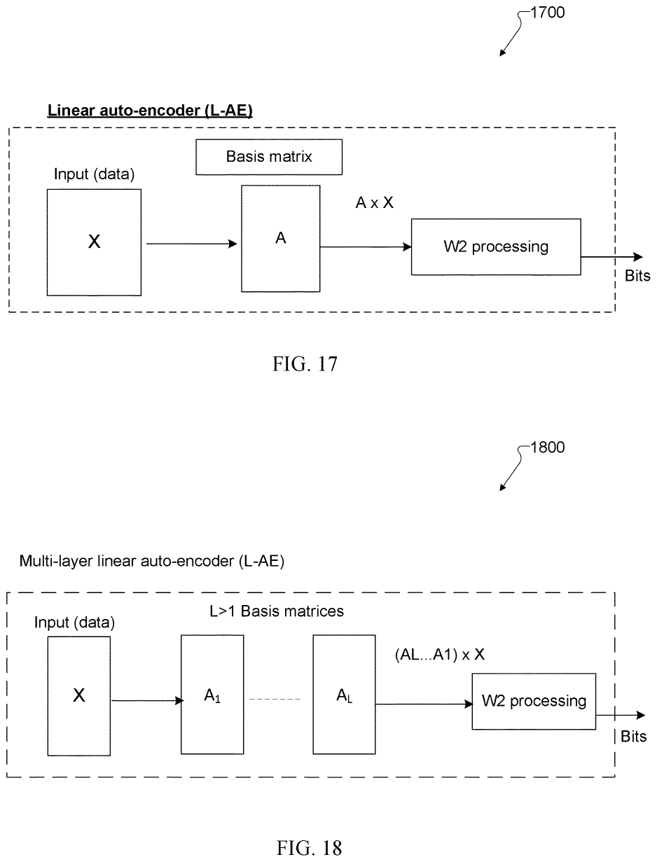

FIG. 17 illustrates an example linear auto encoder 1700 according to embodiments of the present disclosure. For example, the UE 116 of FIG. 3 can be configured to use the linear auto encoder 1700. This example is for illustration only and other embodiments can be used without departing from the scope of the present disclosure.

In one example, the one-sided AE includes linear components such as a dense layer based on a matrix multiplication, as shown in FIG. 17, wherein the input X is processed linearly via a matrix A whose output (column) dimension is set according to the desired CSI compression (number of bits or number of reported neurons/coefficients). The resultant A×X coefficients are quantized via W2 processing block. This block can be according to the W2 quantization scheme of Rel-16 NR eType II codebook.

FIG. 18 illustrates an example multi-layer linear auto encoder 1800 according to embodiments of the present disclosure. For example, the UE 116 of FIG. 3 can be configured to use the multi-layer linear auto encoder 1800. This example is for illustration only and other embodiments can be used without departing from the scope of the present disclosure.

In one example, an extension to multiple (L>1) layers is shown in FIG. 18, wherein there are basis matrices A₁, . . . , A_{L} of appropriate dimensions such that the overall basis is a multiplication A=A_{L}× . . . ×A₁. Let aᵢ×bᵢ is the size of matrix Aᵢ, where i=1, . . . ,L. In one example, bᵢ₋₁=aᵢ for i≥2.

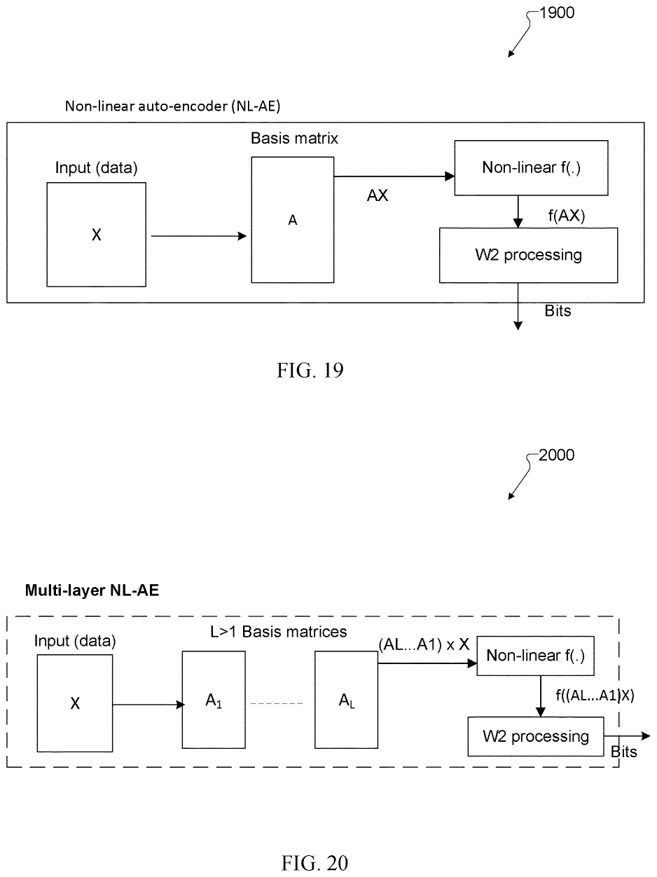

FIG. 19 illustrates an example non-linear auto encoder 1900 according to embodiments of the present disclosure. For example, the UE 116 of FIG. 3 can be configured to use the non-linear auto encoder 1900. This example is for illustration only and other embodiments can be used without departing from the scope of the present disclosure.

In one embodiment, the one-sided AE includes linear components such matrix multiplication, as well as at least one non-linear (NL) component (or activation function), as shown in FIG. 19, wherein the input X is processed linearly via a matrix A whose output is passed to a non-linear activation function/block (e.g., xReLU). The output dimension is set according to the desired CSI compression (number of bits). The resultant f_{NL}(AX) coefficients are quantized via W2 processing block. This block can be according to the W2 quantization scheme of Rel-16 NR eType II codebook.

FIG. 20 illustrates an example multi-layer non-linear auto encoder 2000 according to embodiments of the present disclosure. For example, the UE 116 of FIG. 3 can be configured to use the multi-layer non-linear auto encoder 2000. This example is for illustration only and other embodiments can be used without departing from the scope of the present disclosure.

In one embodiment, an extension to multiple (L>1) layers is shown in FIG. 16, wherein there are basis matrices A₁, . . . , A_{L} of appropriate dimensions such that the overall basis is a multiplication A=A_{L}× . . . ×A₁. This AE can be parameterized by parameter(s) P according to at least one of the following examples:

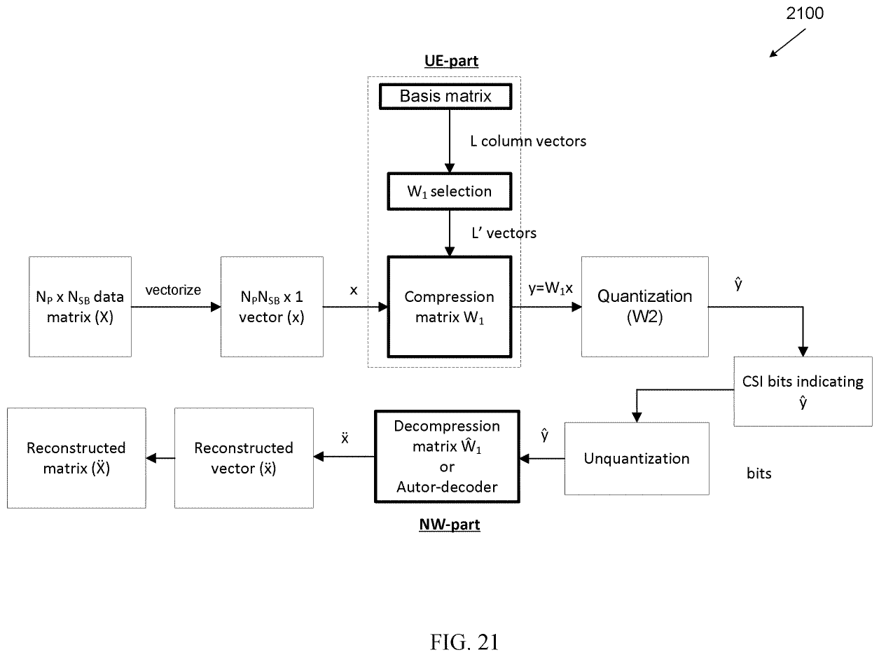

FIG. 21 illustrates an example of reconstructing the channel state information (CSI) data matrix 2100 according to embodiments of the present disclosure. For example, the UE 116 of FIG. 3 can be configured to use the reconstructing the CSI data matrix 2100. This example is for illustration only and other embodiments can be used without departing from the scope of the present disclosure.

In one embodiment, the model for a 1D basis (e.g., W1 in SD or joint basis in SD and FD) is parameterized with respect to a 1D basis-related information. In one example, the information can be the size of the Kernel/basis vector (L×1) where L is a length of the Kernel/basis vector. In one example, the UE is configured with a Kernel/basis or its parameter (e.g., via higher layer RRC, or via dynamic MAC CE or/and DCI indication). As example of supported set of values of L is shown in Table 2.

TABLE 2

| | Kernel |
|---|---|
| ParamCombination | size |
| 0 | (L₀, M₀) |
| 1 | (L₁, M₁) |
| 2 | (L₂, M₂) |
| . . . | . . . |

In one embodiment, the information can be the size of the basis matrix (Z×L) where Z is dimension of the data, and L is a dimension (or number) of the Kernel or basis.
In one example, the basis matrix is in SD, and the value Z is based on P ports, e.g., Z=P or

$$Z = \frac{P}{2} .$$

In one example, the basis matrix is joint in SD and FD, and the value Z is based on P ports and N_{SB} SBs or N₃ FD units, e.g., Z=PN_{SB} or

$$Z = \frac{P {N}_{S B}}{2}$$

### or Z=PN₃ or

$$Z = \frac{P {N}_{3}}{2} .$$

The input data vectors {x} are multiplied with the basis matrix, the output {y} is quantized and reported by the UE as the CSI report. In one example, y=xW₁ where x is a row vector. In one example,

$$y = {W}_{1}^{H}$$

x where x is a column vector.

In one embodiment, the UE is configured to receive the basis matrix (Z×L), as described earlier, and select L′ vectors out of L columns of the basis matrix, where 1≤L′≤L. The selected L′ vectors comprise W₁. The information about this selection is reported by the UE (e.g., via an indicator such as PMI component i₁ or i_{1,x} where x is a number belonging to {0,1,2, . . . }). For instance, a length L bit sequence can be used for this purpose, where a bit value bᵢ=1 indicates selection of the i-th column of the basis matrix, and a bit value bᵢ=0 indicates that the i-th column of the basis matrix is not selected.

In one embodiment, the value of L′ is fixed (e.g., L/2) or configured (e.g., via an RRC parameter or MAC CE or DCI codepoint). In this case, a combinatorial indicator taking a value from {0,1, . . . ,

$$( \begin{matrix}L \\ {L}^{′}\end{matrix} ) - 1 \}$$

and requiring

$$⌈ {log}_{2} ( \begin{matrix}L \\ {L}^{′}\end{matrix} ) ⌉ bits$$

for reporting can be used.

This is illustrated in FIG. 21. The UE compresses the (CSI) data matrix as described earlier, and reports the quantized output/coefficients to the NW. The NW-part unquantizes the received CSI bits, and performs decompression/reconstruction (e.g., using a reconstruction matrix or auto-decoder) in order to reconstruct the (CSI) data matrix.

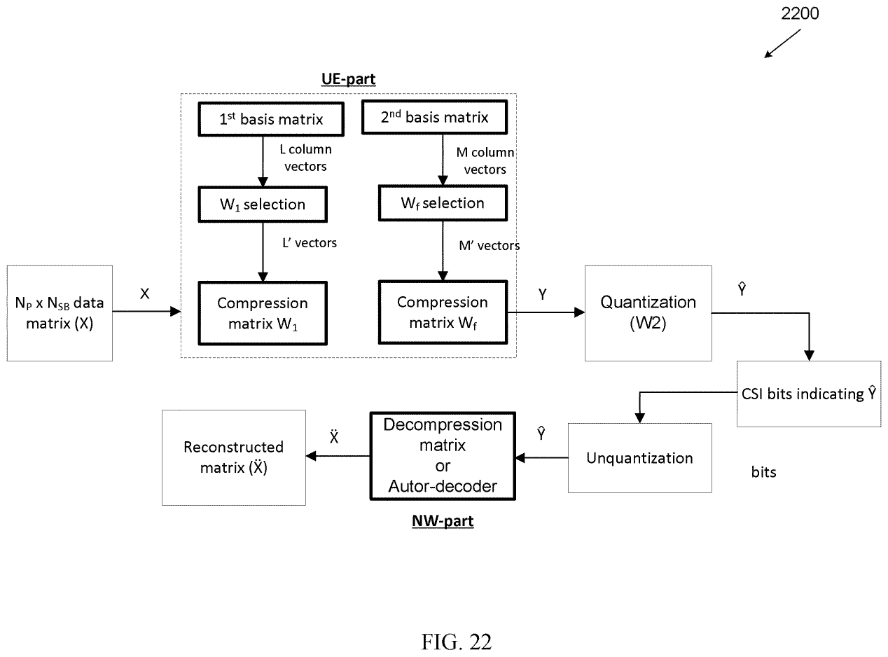

FIG. 22 illustrates another example of reconstructing the CSI data matrix 2200 according to embodiments of the present disclosure. For example, the UE 116 of FIG. 3 can be configured to use the reconstructing the CSI data matrix 2200. This example is for illustration only and other embodiments can be used without departing from the scope of the present disclosure.

In one embodiment, the model for a 2D basis (e.g., W1 in SD and Wf in FD) is parameterized with respect to a 2D basis-related information. In one example, the information can be the size of the Kernel matrix (L×M) where L is a number of rows and M is a number of columns of the Kernel. In one example, the UE is configured with a Kernel or its parameters (e.g., via higher layer RRC, or via dynamic MAC CE or/and DCI indication).

In one example, the information can be the size of the two basis matrices, the first matrix of size (P×L) or

$$( \frac{P}{2} \times L )$$

and the second matrix of size (N_{SB}, M) or (N₃, M) where P×N_{SB} or P×N₃ is dimension of the data matrix (e.g., eigenvectors across SBs), and L is a dimension (or number) of the Kernel or basis in SD, and M is a dimension (or number) of the Kernel or basis in FD.

The input data vectors {x} are multiplied with the basis matrix, the output {y} is quantized and reported by the UE as the CSI report. In one example,

$$Y = {w}_{f}^{H} {XW}_{1}$$

where X is the data matrix. In one example,

$$Y = {W}_{1}^{H} {XW}_{f} .$$

In one embodiment, the UE is configured to receive the first matrix of size (P×L) or

$$( \frac{P}{2} \times L ) ,$$

as described earlier, and select L′ vectors out of L columns of the basis matrix, where 1≤L′≤L. The selected L′ vectors comprise W₁. The information about this selection is reported by the UE (e.g., via an indicator such as PMI component i_{1,1} or i_{1,x} where x is a number belonging to {0,1,2, . . . }). For instance, a length L bit sequence can be used for this purpose, where a bit value bᵢ=1 indicates selection of the i-th column of the basis matrix, and a bit value bᵢ=0 indicates that the i-th column of the basis matrix is not selected.

In one embodiment, the value of L′ is fixed (e.g., L/2) or configured (e.g., via an RRC parameter or MAC CE or DCI codepoint). In this case, a combinatorial indicator taking a value from {0,1, . . . ,

$$( \begin{matrix}L \\ {L}^{′}\end{matrix} ) - 1 \}$$

and requiring

$$⌈ {log}_{2} ( \begin{matrix}L \\ {L}^{′}\end{matrix} ) ⌉ bits$$

for reporting can be used.

In one embodiment, the UE is configured to receive the second matrix of size (N_{SB}, M) or (N₃, M), as described earlier, and select M′ vectors out of M columns of the basis matrix, where 1≤M′≤M. The selected M′ vectors comprise Wf. The information about this selection is reported by the UE (e.g., via an indicator such as PMI component i_{1,2} or i_{1,y} where y is a number belonging to {0,1,2, . . . }). For instance, a length M bit sequence can be used for this purpose, where a bit value bᵢ=1 indicates selection of the i-th column of the basis matrix, and a bit value bᵢ=0 indicates that the i-th column of the basis matrix is not selected.

In one embodiment, the value of M′ is fixed (e.g., M/2) or configured (e.g., via an RRC parameter or MAC CE or DCI codepoint). In this case, a combinatorial indicator taking a value from {0,1, . . . ,

$$( \begin{matrix}M \\ {M}^{′}\end{matrix} ) - 1 \}$$

and requiring

$$⌈ {log}_{2} ( \begin{matrix}M \\ {M}^{′}\end{matrix} ) ⌉ bits$$

for reporting can be used. In this case, a combinatorial indicator taking a value from {0,1, . . . ,

$$( \begin{matrix}M - 1 \\ {M}^{′} - 1\end{matrix} ) - 1 \}$$

and requiring

$$⌈ {log}_{2} ( \begin{matrix}M - 1 \\ {M}^{′} - 1\end{matrix} ) ⌉ bits$$

for reporting can be used where it is assumed that one of the M′ is fixed, e.g., to a 1^{st} column of the second basis matrix or the column corresponding to the all one vector.

This is illustrated in FIG. 22. The UE compresses the (CSI) data matrix as described earlier, and reports the quantized output/coefficients to the NW. The NW-part unquantizes the received CSI bits, and performs decompression/reconstruction (e.g., using a reconstruction matrix or auto-decoder) in order to reconstruct the (CSI) data matrix.

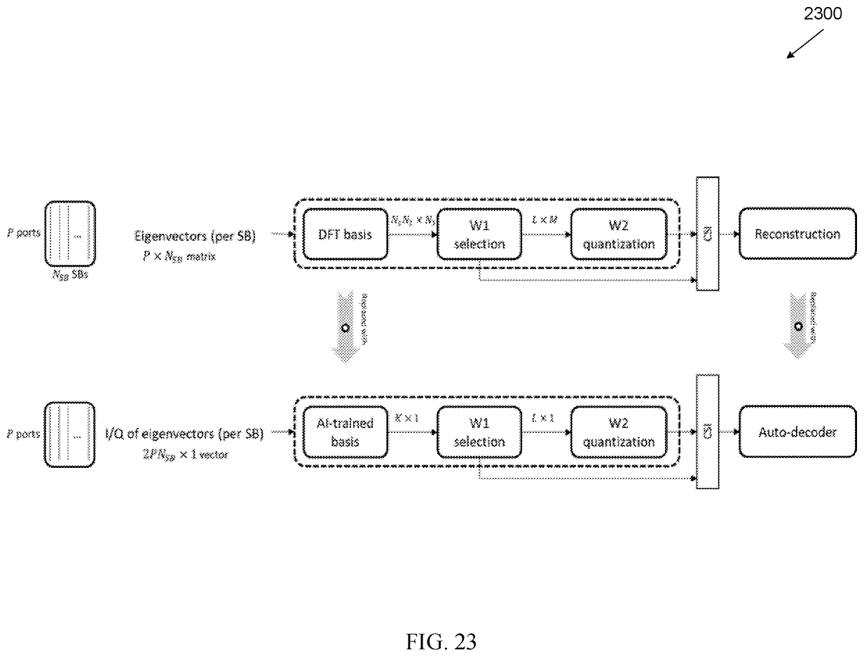

FIG. 23 illustrates an example of configuring a UE with a CSI report based on a codebook having a basis in a SD and a FD 2300 according to embodiments of the present disclosure. For example, the UE 116 of FIG. 3 can be configured to use the example of configuring a UE with a CSI report based on a codebook having a basis in a SD and a FD 2300. This example is for illustration only and other embodiments can be used without departing from the scope of the present disclosure.

In one embodiment, a UE is configured with a CSI report based on a codebook where the codebook is either a fixed-basis codebook or a learning-based AI-trained basis. In one example, the basis is in SD. In one example, the basis in SD and FD. In one example, the basis is in SD, FD, and DD. When the basis is in SD and FD, it can correspond to a joint basis across SD and FD or a pair of two separate bases, one for SD and another for FD. In one example, the input to this SD and FD bases is a P×N_{SB} matrix (e.g., which correspond to length-P eigenvectors of N_{SB} SBs). The input is projected on the bases and the projected output (referred to as coefficients) are then processed and quantized for reporting. In one example, the input is a vector of size PN_{SB}×1 (e.g., obtained by vectorizing N_{SB} eigenvectors, each of length P). In one example, the input is a vector of size 2PN_{SB}×1 where 2 corresponds to the I/Q or real/imaginary parts of the complex input vector. An example of the basis in SD and FD is shown in.

When the basis is a fixed-basis, it is based on DFT wherein in SD, the DFT is 2D with a size N₁N₂ (for 2D antenna port layouts) and in FD, the DFT is 1D with a size/length N₃. From this N₁N₂×N₃ DFT (SD, FD) basis vector pairs, the UE selects a subset L×M, L out of N₁N₂ in SD and M out of N₃ in FD. This is referred to as W₁ selection. The selected L SD DFT vectors are common (the same) for two polarizations of a dual-polarized antenna port layouts. The resultant LM or 2LM (for dual-pol) coefficients are quantized, referred to as W₂ quantization. In one example, the codebook and the scheme for this fixed-basis based codebook is according to Rel-16 5G NR, enhanced Type II codebook. For CSI reporting,

When the basis is a learning-based AI-trained basis, the basis is learnt/trained via an AIML algorithm. Let K be the number of learnt basis vectors. The size of the basis is Z×K or K×Z where Z=2PN_{SB} (real basis) or PN_{SB} (complex basis). When the model is a two-sided model, the leaned AI-trained basis is coupled (or leant together) with a corresponding auto-decoder (to be used at the NW to decode the CSI). When number of layers (rank) is more than one, the CSI is calculated and processed in a per layer fashion.

Four example schemes based on the learning-based AI-trained basis is tabulated in Table 3. The basis is a joint SD/FD basis in all four schemes.
In Schemes 1 and 2, the UE selects L out of the K basis vectors freely, where 1≤L≤K. In one example, the information (e.g., indices of selected vectors) about this selection can be reported via a bitmap of length K.
In Schemes 3 and 4, the UE selects L out of the K basis vectors, where the value of L is predetermined or configured to the UE, e.g.,

$$L = \frac{K}{2} .$$

In one example, the information (e.g., indices of selected vectors) about this selection can be reported via a combinatorial indicator of

$$⌈ {log}_{2} ( \begin{matrix}K \\ L\end{matrix} ) ⌉ bits .$$

In Schemes 1 and 3, the W₂ quantization scheme is as follows. The amplitude is reported via a differential reporting (a reference amplitude and a differential amplitude relative to the reference) akin to the amplitude reporting in Rel.16 5G NR enhanced Type II codebook. In particular, a reference amplitude (common for all coefficients) is reported using a 4-bit codebook (Table 5.2.2.2.5-2 of TS. 38.214, copied below) and the differential amplitudes for each of the coefficients is reported using a k-bit codebook where k∈{1,2,3}. In one example, the codebook for k=3 is according to Table 5.2.2.2.5-3 of TS. 38.214, copied below. In one variation, the codepoint 0 (indicating

$$\frac{2}{8 \sqrt{2}} )$$

is replaced with an amplitude value 0. When k=2, the four codepoints are {4,5,6,7} or {0,5,6,7}. Or, when k=2, the three codepoints are {5,6,7} and the fourth is set to 0. Or, when k=2, the three codepoints are a subset of codepoints {1, . . . ,7} and the fourth is set to 0. Or, when k=2, the four codepoints are a subset of codepoints {0,1, . . . ,7}. Or, the UE selects the four out of 8 codepoints and reports the selected codepoints (as part of the CSI report, e.g., via part 1 of a two-part UCI or CSI). The phase is reported via a 1-bit sign indicator indicating a value from {-1,1}.
In Schemes 2 and 4, the W₂ quantization scheme is the same as that for Scheme 1 and 3 except that there is no phase reporting. The phase of all coefficients are fixed to 1 indicating that all coefficients are positive or non-negative.

TABLE 3

| | Basis | W1 | W2 | CSI payload |
|---|---|---|---|---|
| | (joint SD/FD) | selection | quantization | (#bits) |
| Scheme 1 | Unstructured K × | L out of K | Amplitude | K + 4 + 3L |
| | 2PN_{SB} matrix | (length-K | 4-bit ref. | |
| | P: number of ports | bitmap) | amp | |
| | N_{SB}: number of | | 2-bit diff. | |
| | SBs | | amp | |
| | | | Phase: 1-bit | |
| | | | (sign) | |
| Scheme 2 | | | Amplitude | K + 4 + 2L |
| | | | (positive) | |
| | | | 4-bit ref. | |
| | | | amp | |
| | | | 2-bit diff. | |
| | | | amp | |
| Scheme 3 | | L < K, e.g., | Amplitude 4-bit ref. | $⌈ {log}_{2} ( \begin{matrix}K \\ L\end{matrix} ) ⌉ + 4 +$ |
| | | $L = \frac{K}{2}$ | amp 2-bit diff. | 3L |
| | | (K choose | amp | |
| | | L) | Phase: 1-bit | |
| | | | (sign) | |
| Scheme 4 | | | Amplitude (positive) | $⌈ {log}_{2} ( \begin{matrix}K \\ L\end{matrix} ) ⌉ + 4 +$ |
| | | | 4-bit ref. | 2L |
| | | | amp | |
| | | | 2-bit diff. | |
| | | | amp | |

TABLE 5.2.2.2.5-2
$Mapping elements of {i}_{2 , 3 , l} : {k}_{l , p}^{( 1 )} to {p}_{l , p}^{( 1 )}$

| ${k}_{l , p}^{( 1 )}$ | ${p}_{l , p}^{( 1 )}$ |
|---|---|
| 0 | Reserved |
| 1 | $\frac{1}{\sqrt{128}}$ |
| 2 | ${( \frac{1}{8192} )}^{1 / 4}$ |
| 3 | $\frac{1}{8}$ |
| 4 | ${( \frac{1}{2048} )}^{1 / 4}$ |
| 5 | $\frac{1}{2 \sqrt{8}}$ |
| 6 | 69 |
| 7 | $\frac{1}{4}$ |
| 8 | ${( \frac{1}{128} )}^{1 / 4}$ |
| 9 | $\frac{1}{\sqrt{8}}$ |
| 10 | ${( \frac{1}{32} )}^{1 / 4}$ |
| 11 | $\frac{1}{2}$ |
| 12 | ${( \frac{1}{8} )}^{1 / 4}$ |
| 13 | $\frac{1}{\sqrt{2}}$ |
| 14 | ${( \frac{1}{2} )}^{1 / 4}$ |
| 15 | 1 |

$Mapping elements of {i}_{2 , 4 , l} : {k}_{l , i , f}^{( 2 )} to {p}_{l , i , f}^{( 2 )}$

| ${k}_{l , p}^{( 2 )}$ | ${P}_{l , i , f}^{( 2 )}$ |
|---|---|
| 0 | $\frac{1}{8 \sqrt{2}}$ |
| 1 | $\frac{1}{8}$ |
| 2 | $\frac{1}{4 \sqrt{2}}$ |
| 3 | $\frac{1}{4}$ |
| 4 | $\frac{1}{2 \sqrt{2}}$ |
| 5 | $\frac{1}{2}$ |
| 6 | $\frac{1}{\sqrt{2}}$ |
| 7 | 1 |

In one embodiment, a UE is configured with a CSI report, as described herein, where the CSI report is multiplexed together with a UCI via parameters as shown in Table 4. The UCI parameters include RI, CQI (per CW), and PMI, where the PMI includes components:
Selection of L basis vectors (W1 selection)
If strongest coefficient indicator (SCI) is reported
   amplitude/phase values of remaining L−1 coefficients
   amplitude/phase value of the strongest coefficient is set to 1, hence is not reported
If SCI is not reported
   amplitude/phase values of remaining L−1 coefficients
For CJT-Model1, the UCI parameters are the same as described above.
For CJT-Model2, the selection of L basis vectors are specific to each PG (based on respective AI-trained bases), hence there is a UCI parameter for each PG, and the rest of the UCI parameters are the same as described above.

TABLE 4
UCI parameters for AI-native CSI

| P_{g} | Scheme | RI | CQI | PMI |
|---|---|---|---|---|
| 1 | Single PG | Up to 2 | WB/SB | Basis matrix: 2P_{CSIRS}N_{SB} × K |
| | L >1, N_{g} = 1 | or 4 | (per | (Joint SD-FD) basis vector indicator (i_{1,1,l}), |
| | PG | | CW) | indicating L out of K column vectors |
| | | | | Alt1: Bitmap: 1 ≤ L ≤ K, UE-selected |
| | | | | Strongest coefficient indicator (i_{1,8,l}): |
| | | | | Alt1: if reported: ┌log₂┐ K bits |
| | | | | Alt2: if not reported: 2 + 1 = 3 bits for |
| | | | | amp/phase |
| | | | | Reference amplitude indicator (i_{2,3,l}): Rel-16 4-bit |
| | | | | CB |
| | | | | NZC amplitude indicator (i_{2,4,l}): k bits, k = 1, 2, 3, |
| | | | | subset of Rel-16 3-bit CB |
| | | | | NZC phase indicator (i_{2,5,l}): 1 bit |
| | | | | Scheme 1: 1-bit (sign) |
| >1 | CJT-Model1: 1 model per | | | $Basis matrix : 2 ( {\sum }_{r = 1}^{{N}_{g}} {P}_{CSIRS , r} ) {N}_{S B} \times K$ |
| | CJT set | | | Ng PCSIRS, NSB X K |
| | CJT: L > | | | (Joint PG-SD-FD) basis vector indicator (i_{1,1,l}), |
| | 1, N_{g} PGs | | | indicating L out of K column vectors |
| | | | | The rest is the same as (or simple extension of) |
| | | | | N_{g} = 1 case |
| >1 | CJT-Model2: | | | For PG r with PCSIRS,r ports, Basis matrix: |
| | 1 model per PG | | | 2P_{CSIRS,r}N_{SB} × K |
| | per CJT set | | | (Joint SD-FD) basis vector indicator (i_{1,1,r,l}), |
| | CJT: Ly > | | | indicating Lᵣ out of K column vectors |
| | 1, N_{g} PGs | | | The rest is the same as (or simple extension of) |
| | | | | N_{g} = 1 case |

For a given CSI report n, when SCI is reported, each reported element of indices i_{2,4,l}, i_{2,5,l} and i_{1,1,l}, indexed by l, i, is associated with a priority value Pri(l, i) with l=1,2, . . . , υ, i=0,1, . . . , L−1. The element with the highest priority has the lowest associated value Pri(l, i). Omission of Part 2 CSI is according to the priority order shown in Table 5.2.3-1, where
Group 0 includes indices i_{1,1,l} or i_{1,1,r,l} (if reported), and i_{1,8,l} (if reported, l=1, . . . , υ) and the second wideband CQI (if reported).
Group 1 includes indices i_{2,3,l}, the

$$max ( 0 , ⌈ \frac{{K}^{N Z}}{2} ⌉ - υ )$$

highest priority elements of i_{2,4,l} and the

$$max ( 0 , ⌈ \frac{{K}^{N Z}}{2} ⌉ - υ )$$

highest priority elements of i_{2,5,l} (l=1, . . . , υ) and the second subband CQI of even subbands (if reported).
Group 2 includes the min

$$( {K}^{N Z} - ν , ⌊ \frac{{K}^{N Z}}{2} ⌋ )$$

lowest priority elements of i_{2,4,l} and the

$$min ( {K}^{N Z} - ν , ⌊ \frac{{K}^{N Z}}{2} ⌋ ) .$$

lowest priority elements of i_{2,5,l} (l=1, . . . , υ) and the second subband CQI of odd subbands (if reported).

For a given CSI report n, when SCI is not reported, each reported element of indices i_{2,4,l}, i_{2,5,l} and i_{1,1,l}, indexed by l, i, is associated with a priority value Pri(l, i) with l=1,2, . . . , υ, i=0,1, . . . , L−1. The element with the highest priority has the lowest associated value Pri(l, i). Omission of Part 2 CSI is according to the priority order shown in Table 5.2.3-1, where
Group 0 includes indices i_{1,1,l} or i_{1,1,r,l} (if reported), and the second wideband CQI (if reported).
Group 1 includes indices i_{2,3,l}, the

$$max ( 0 , ⌈ \frac{{K}^{N Z}}{2} ⌉ )$$

highest priority elements of i_{2,4,l} and the

$$max ( 0 , ⌈ \frac{{K}^{N Z}}{2} ⌉ )$$

highest priority elements of i_{2,5,l} (l=1, . . . , υ) and the second subband CQI of even subbands (if reported).
Group 2 includes the

$$min ( {K}^{N Z} , ⌊ \frac{{K}^{NZ}}{2} ⌋ )$$

lowest priority elements of i_{2,4,l} and the

$$min ( {K}^{N Z} , ⌊ \frac{{K}^{NZ}}{2} ⌋ )$$

lowest priority elements of i_{2,5,l} (l=1, . . . , υ) and the second subband CQI of odd subbands (if reported).

TABLE 5.2.3-1
Priority reporting levels for Part 2 CSI

Priority 0:
For CSI reports 1 to N_{Rep}, Group 0 CSI for CSI
reports or Part 2 wideband CSI for CSI reports
Priority 1:
Group 1 CSI for CSI report 1, or Part 2 subband
CSI of even subbands for CSI report 1
Priority 2:
Group 2 CSI for CSI report 1, or Part 2 subband
CSI of odd subbands for CSI report 1
Priority 3:
Group 1 CSI for CSI report 2, or Part 2 subband
CSI of even subbands for CSI report 2
Priority 4:
Group 2 CSI for CSI report 2, or Part 2 subband
CSI of odd subbands for CSI report 2
.
.
.
Priority 2N_{Rep} − 1:
Group 1 CSI for CSI report N_{Rep}, or Part 2 subband
CSI of even subbands for CSI report N_{Rep}
Priority 2N_{Rep}:
Group 2 CSI for CSI report N_{Rep}, or Part 2 subband
CSI of odd subbands for CSI report N_{Rep}

In one embodiment, a UE is configured with a CSI report for N_{g}=1 PG, as described herein, where the CSI report is multiplexed together with a UCI via parameters as shown in Table 4. The UCI parameters include RI, CQI (per CW), and PMI, as described above, and partitioned into two parts, part 1 UCI/CSI and part 2 UCI/CSI. An example of the two parts is shown in Table 5.

TABLE 5

| UCI partition | | Content |
|---|---|---|
| Part 1 | | RI, |
| | | WB CQI, SB CQI, |
| | | total number of NZC indicator (value of K^{NZ} = ΣLₗ, let Lₗ be |
| | | for layer l) |
| Part 2 | Group 0 | For each layer, l = 1, . . . , v, |
| | | length-K bitmap indicating Lₗ out of K vectors, |
| | | SCI (if reported) |
| | Group 1 | ${i}_{2 , 3 , l} , ⌈ \frac{{K}^{NZ}}{2} ⌉ NZ coefs : Highest priority bits of {i}_{2 , 4 , l} , {i}_{2 , 5 , l}$ |
| | Group 2 | $⌊ \frac{{K}^{NZ}}{2} ⌋ NZ coefs : Lowest priority bits of {i}_{2 , 4 , l} , {i}_{2 , 5 , l}$ |

| | |
|---|---|
| Priority order | layer → coefficients: Pri(l, i) = v · i + l |
| | for l = 1, . . . , v, i = 0, 1, . . . , Lₗ − 1 |

In one embodiment, a UE is configured with a CSI report for N_{g}>1 PG, as described herein, where the CSI report is multiplexed together with a UCI via parameters as shown in Table 4. The UCI parameters include RI, CQI (per CW), and PMI, as described above, and partitioned into two parts, part 1 UCI/CSI and part 2 UCI/CSI. An example of the two parts is shown in Table 6.

TABLE 6

| UCI partition | | Content |
|---|---|---|
| Part 1 | | RI, a bitmap indicator for TRP selection, |
| | | WB CQI, SB CQI, |
| | | total number of NZC indicator (value of K^{NZ} = ΣLₗ, let Lₗ be for layer l) |
| Part 2 | Group 0 | For each layer, l = 1, . . . , v, |
| | | length-K bitmap indicating Lₗ out of K vectors, |
| | | SCI (if reported) |
| | Group 1 | ${i}_{2 , 3 , l} , ⌈ \frac{{K}^{NZ}}{2} ⌉ NZ coefs : Highest priority bits of {i}_{2 , 4 , l} , {i}_{2 , 5 , l}$ |
| | Group 2 | $⌊ \frac{{K}^{NZ}}{2} ⌋ NZ coefs : Lowest priority bits of {i}_{2 , 4 , l} , {i}_{2 , 5 , l}$ |

| | |
|---|---|
| Priority order | layer → coefficients: Pri(l, i) = v · i + l |
| | for l = 1, . . . , v, i = 0, 1, . . . , Lₗ − 1 |

In one embodiment, a UE is configured with a CSI report for N_{g}>1 PG, as described herein, where the CSI report is multiplexed together with a UCI via parameters as shown in Table 4. The UCI parameters include RI, CQI (per CW), and PMI, as described above, and partitioned into two parts, part 1 UCI/CSI and part 2 UCI/CSI. An example of the two parts is shown in Table 7.

TABLE 7

| UCI partition | | Content |
|---|---|---|
| Part 1 | | RI, a bitmap indicator for TRP selection, |
| | | WB CQI, SB CQI, |
| | | total number of NZC indicator (value of K^{NZ} = ΣL_{l,r}, let Lₗ be for layer l, TRP r) |
| Part 2 | Group 0 | For each (l, r): |
| | | length-Kᵣ bitmap indicating L_{l,r} out of Kᵣ vectors, |
| | | SCI (if reported) |
| | Group 1 | ${i}_{2 , 3 , l} , ⌈ \frac{{K}^{NZ}}{2} ⌉ NZ coefs : Highest priority bits of {i}_{2 , 4 , l} , {i}_{2 , 5 , l}$ |
| | Group 2 | $⌊ \frac{{K}^{NZ}}{2} ⌋ NZ coefs : Lowest priority bits of {i}_{2 , 4 , l} , {i}_{2 , 5 , l}$ |

| | |
|---|---|
| | layer → coefficients |
| | $No TRP selection : Pri ( l , {i}_{j} , j ) = υ \cdot ( {\sum }_{r = 1}^{j - 1} {L}_{l , r} + {i}_{j} ) + l$ |
| | for l = 1, . . . , v, iⱼ = 0, 1, . . . , L_{l,j} − 1, and j = 1, . . . , N_{TRP} |
| Priority order | $TRP selection : Pri ( l , {i}_{j} , j ) = υ \cdot ( {\sum }_{r = 1}^{j - 1} {L}_{l , {σ}_{r}} + {i}_{j} ) + l$ |
| | for l = 1, . . . , v, iⱼ = 0, 1, . . . , L_{l,σ}_{ⱼ} − 1, and j = 1, . . . , N₀, |
| | where {σ₁, . . . , σ_{N0}} are the indices of the N₀ selected TRPs in increasing order, |
| | such that 1 ≤ σ₁ < · · · < σ_{N0} ≤ N_{TRP}. |

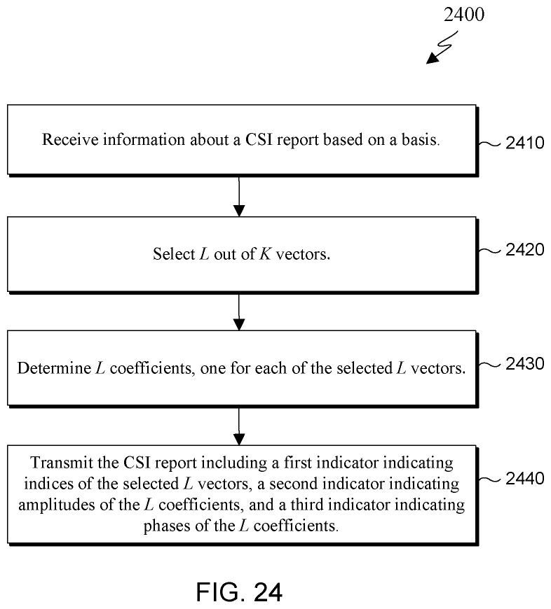

FIG. 24 illustrates an example method 2400 performed by a UE in a wireless communication system according to embodiments of the present disclosure. The method 2400 of FIG. 24 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2400 is for illustration only and other embodiments can be used without departing from the scope of the present disclosure.

The method 2400 begins with the UE receiving information about a CSI report based on a basis (2410). For example, in 2410, the basis comprises K vectors, and the basis is associated with P ports and N_{SB} SBs, where K>1. In various embodiments, the UE also receives the basis. In various embodiments, the basis is trained via an AI/ML algorithm. In various embodiments, a size of the basis is K×Z, where Z=2PN_{SB} or PN_{SB}, and the basis is coupled with an auto-decoder for decoding of the CSI report.

The UE then selects L out of K vectors, where 1≤L≤K (2420). The UE then determines L coefficients, one for each of the selected L vectors (2430). The UE then transmits the CSI report including a first indicator indicating indices of the selected L vectors, a second indicator indicating amplitudes of the L coefficients, and a third indicator indicating phases of the L coefficients (2440). In various embodiments, the UE determines a strongest coefficient out of the L coefficients, and the CSI report includes a fourth indicator indicating an index of the strongest coefficient. In various embodiments, the first indicator is a bit sequence b₁b₂ . . . b_{K} of length K, where bᵢ=0 indicates that an i-th of the K vectors is not selected and bᵢ=1 indicates that the i-th of the K vectors is selected. In various embodiments, a value of L is predetermined or configured, and the first indicator is a combinatorial indicator requiring

$$⌈ {log}_{2} ( \begin{matrix}K \\ L\end{matrix} ) ⌉ bits .$$

In various embodiments, the second indicator requires 4+2 L bits, 4 bits indicating a reference amplitude value, and 2 L bits with 2 bits per coefficient indicating a differential amplitude value for each of the L amplitudes. The third indicator requires L bits with 1 bit per coefficient indicating a phase value for each of the L phases.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the FIGURES illustrate different examples of user equipment, various changes may be made to the FIGURES. For example, the user equipment can include any number of each component in any suitable arrangement. In general, the FIGURES do not limit the scope of the present disclosure to any particular configuration(s). Moreover, while FIGURES illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to receive information about a channel state information (CSI) report based on a basis, wherein the basis comprises K vectors, and the basis is associated with P ports and N_{SB} SBs, where K>1; and
a processor operably coupled to the transceiver, the processor configured to:
select L out of K vectors, where 1≤L≤K, and
determine L coefficients, one for each of the selected L vectors,
wherein the transceiver is further configured to transmit the CSI report including:
a first indicator indicating indices of the selected L vectors,
a second indicator indicating amplitudes of the L coefficients, and
a third indicator indicating phases of the L coefficients.

2. The UE of claim 1, wherein the transceiver is further configured to receive the basis.

3. The UE of claim 1, wherein the basis is trained via an artificial intelligence/machine learning (AI/ML) algorithm.

4. The UE of claim 1, wherein:
the processor is further configured to determine a strongest coefficient out of the L coefficients, and
the CSI report includes a fourth indicator indicating an index of the strongest coefficient.

5. The UE of claim 1, wherein:
a size of the basis is K×Z, where Z=2PN_{SB} or PN_{SB}, and
the basis is coupled with an auto-decoder for decoding of the CSI report.

6. The UE of claim 1, wherein:
the first indicator is a bit sequence b₁b₂ . . . b_{K} of length K, where:
bᵢ=0 indicates that an i-th of the K vectors is not selected, and
bᵢ=1 indicates that the i-th of the K vectors is selected.

7. The UE of claim 1, wherein:
a value of L is predetermined or configured, and
the first indicator is a combinatorial indicator requiring
$$⌈ {log}_{2} ( \begin{matrix}K \\ L\end{matrix} ) ⌉ bits .$$

8. The UE of claim 1, wherein:
the second indicator requires 4+2 L bits, 4 bits indicating a reference amplitude value, and 2 L bits with 2 bits per coefficient indicating a differential amplitude value for each of the L amplitudes, and
the third indicator requires L bits with 1 bit per coefficient indicating a phase value for each of the L phases.

9. A base station (BS), comprising:
a processor; and
a transceiver operably coupled to the processor, the transceiver configured to:
transmit information about a channel state information (CSI) report based on a basis, wherein the basis comprises K vectors, and the basis is associated with P ports and N_{SB} SBs, where K>1; and
receive the CSI report including:
a first indicator indicating indices of L vectors selected out of the K vectors, where 1≤L≤K,
a second indicator indicating amplitudes of L coefficients, one for each of the L vectors, and
a third indicator indicating phases of the L coefficients.

10. The BS of claim 9, wherein the transceiver is further configured to transmit the basis.

11. The BS of claim 9, wherein the basis is trained via an artificial intelligence/machine learning (AI/ML) algorithm.

12. The BS of claim 9, wherein the CSI report includes a fourth indicator indicating an index of a strongest coefficient out of the L coefficients.

13. The BS of claim 9, wherein:
a size of the basis is K×Z, where Z=2PN_{SB} or PN_{SB}, and
the basis is coupled with an auto-decoder for decoding of the CSI report.

14. The BS of claim 9, wherein:
the first indicator is a bit sequence b₁b₂ . . . b_{K} of length K, where:
bᵢ=0 indicates that an i-th of the K vectors is not selected, and
bᵢ=1 indicates that the i-th of the K vectors is selected.

15. The BS of claim 9, wherein:
a value of L is predetermined or configured, and
the first indicator is a combinatorial indicator requiring
$$⌈ {log}_{2} ( \begin{matrix}K \\ L\end{matrix} ) ⌉ bits .$$

16. The BS of claim 9, wherein:
the second indicator requires 4+2 L bits, 4 bits indicating a reference amplitude value, and 2 L bits with 2 bits per coefficient indicating a differential amplitude value for each of the L amplitudes, and
the third indicator requires L bits with 1 bit per coefficient indicating a phase value for each of the L phases.

17. A method performed by a user equipment (UE), the method comprising:
receiving information about a channel state information (CSI) report based on a basis, wherein the basis comprises K vectors, and the basis is associated with P ports and N_{SB} SBs, where K>1;
selecting L out of K vectors, where 1≤L≤K;
determining L coefficients, one for each of the selected L vectors; and
transmitting the CSI report including:
a first indicator indicating indices of the selected L vectors,
a second indicator indicating amplitudes of the L coefficients, and
a third indicator indicating phases of the L coefficients.

18. The method of claim 17, further comprising receiving the basis.

19. The method of claim 17, wherein the basis is trained via an artificial intelligence/machine learning (AI/ML) algorithm.

20. The method of claim 17, further comprising:
determining a strongest coefficient out of the L coefficients,
wherein the CSI report includes a fourth indicator indicating an index of the strongest coefficient.
